(19) United States
(12) Patent Application Publication
(10) Pub. No.: US 2010/0017395 A1
(43) Pub. Date: Jan. 21, 2010

(54) APPARATUS AND METHODS FOR TRANSFORMING RELATIONAL QUERIES INTO MULTI-DIMENSIONAL QUERIES

(75) Inventors: Tal WAYN, Modiin (IL); Leonid ORE, Modiin (IL)

Correspondence Address: OLIFF & BERRIDGE, PLC, P.O. BOX 320850, ALEXANDRIA, VA, 22320-4850, US

(73) Assignee: Sapphire Information Systems Ltd., Modiin (IL)

(21) Appl. No.: 12/472,949

(22) Filed: May 27, 2009

Related U.S. Application Data
(60) Provisional application No. 61/081,376, filed on Jul. 16, 2008.

(51) Int. Cl. G06F 17/30

(52) U.S. Cl. 707/5; 707/E17.014

(57) ABSTRACT

A query processor operative to accept queries with respect to data and to formulate responses to the queries and a data system comprising a query analyzer operative to perform breakdown analysis of queries thereby to generate a hierarchical representation of queries and a hierarchical query storage unit operative to store the hierarchical representations. A hierarchical representation processor operative to receive hierarchically represented queries and to formulate all possible multi dimensional roles of its query elements; and a multi dimensional role storage unit operative to store the hierarchical representations with their respective multi dimensional roles. A stochastic query processor operative to accept the hierarchical representations with their respective multi dimensional roles and to eliminate all improbable combinations of query elements (clause components) and multi dimensional roles. Hierarchical representations with their respective multi dimensional roles query processor operative to accept hierarchical representations with their respective multi dimensional roles from a data storage unit and to formulate most probable multidimensional representation of initial relational query.

### REFERENCE TO CO-PENDING APPLICATIONS

Priority is claimed from U.S. provisional application No. 61/081,376, entitled “Apparatus And Methods For Transforming Relational Queries Into Multi-Dimensional Queries” and filed on Jul. 16, 2008.

### FIELD OF THE INVENTION

The present invention relates generally to databases and more particularly to querying of databases.

### BACKGROUND OF THE INVENTION

IBM Solution is a commercially available system which converts relational databases into Online Analytical Processing (OLAP) cubes. This system typically takes the relational database ‘as is’ and converts it, perhaps including parts of the database which are not of interest and/or will never be queried, into an Online Analytical Processing (OLAP) cube.

A state of the art OLAP model building system is described in United States Patent Application 2004/0122646 to Colossi et al, published 24 Jun. 2004.

The disclosures of all publications and patent documents mentioned in this specification, and of the publications and patent documents cited therein directly or indirectly, are hereby incorporated by reference.

### SUMMARY OF THE INVENTION

Certain embodiments of the present invention seek to provide a system that automatically generates a probable, typically the most probable, conversion from SQL expressions to MDX and XMLA expressions with little or no involvement of programmers and system analysts' manual analysis and implementation. The system intelligently utilizes a set of pre-defined rules to analyze an SQL statement and identify probable primary MDX entities such as Dimensions, Hierarchies, Levels, Members and Measures, that may be derived from source expressions, thereby, typically, to map SQL-Statements into maximum possible multidimensional structures to create a framework for further refining an analysis. At a later stage, further analytical procedures may filter illegal MD elements and utilize data mining analysis to identify the most probable MDX statement to represent the original SQL-expression. The output of the system typically comprises a “best suited for customer” multidimensional representation of the original relational expression and may also supply a robust set of functions for the customer's behavior and demands analysis.

According to certain embodiments of the present invention, queries which are formulated in SQL and are designated to the relational database are received and converted to multidimensional expressions, e.g. in MDX format, which is the format that is used for querying an Online Analytical Processing (OLAP) cube. The resulting MDX queries may be analyzed, e.g. manually, so as to generate an Online Analytical Processing (OLAP) cube which corresponds to the queries of interest.

There is thus provided, in accordance with at least one embodiment of the present invention, a data system operative in conjunction with a data storage unit operative to store data and a query processor operative to accept queries with respect to the data in the data storage unit and to formulate responses to the queries by accessing the data storage unit, the data system comprising a query analyzer operative to perform breakdown analysis of queries thereby to generate a hierarchical representation of each of at least some queries received by the query processor; and a hierarchical query storage unit operative to store the hierarchical representations.

Further in accordance with at least one embodiment of the present invention, the query analyzer comprises an apparatus for breaking down an input query on the data storage unit into a set of at least one clause; and an apparatus for recursively breaking down at least one of the plurality of clauses into a set of at least one clause components, thereby to define a hierarchical representation of the input query.

Also provided, in accordance with at least one embodiment of the present invention, is a system for performing breakdown analysis of queries on at least one relational data storage units, the system comprising apparatus for breaking down an input query on a data storage unit into a set of at least one clause; and an apparatus for recursively breaking down at least one of the plurality of clauses into a set of at least one clause component, thereby to define a hierarchy representing the input query and comprising clauses below the input query and clause components below the clauses, wherein some of the clause components axe leaves which are not parents of any other clause component.

Still further in accordance with at least one embodiment of the present invention, the system also comprises a hierarchy analyzer operative to analyze at least one leaf clause component of an individual hierarchy and comprising a leaf clause component characterization unit operative to generate an initial characterization of at least one leaf clause component as at least one of a dimension, a measure within a multi-dimensional query definition language; and a cross-analyzer operative to generate an advanced characterization of at least one leaf clause component as exactly one of a dimension and a measure within a multi-dimensional query definition language.

Additionally in accordance with at least one embodiment of the present invention, the system comprises a meta-data analyzer having access rights to the data storage unit and operative to narrow the initial characterization of at least one leaf clause component which is a field in the data storage unit.

Further in accordance with at least one embodiment of the present invention, the hierarchical query storage unit comprises a parent-child structure.

Still further in accordance with at least one embodiment of the present invention, the input query comprises an SQL statement.

Additionally in accordance with at least one embodiment of the present invention, the input query comprises an XML statement.

Still further in accordance with at least one embodiment of the present invention, the input query is represented as a string of characters.

Further in accordance with at least one embodiment of the present invention, the data storage unit comprises at least one table.

Still further in accordance with at least one embodiment of the present invention, the system also comprises an apparatus for generating an MDX query from the clause components.

Further in accordance with at least one embodiment of the present invention, data stored in the data storage unit is stored in a relational format and wherein the query processor comprises an SQL processor.

Still further in accordance with at least one embodiment of the present invention, the system also comprises an apparatus for generating an MDX query from the clause components by selecting at least one leaf clause component whose advanced characterization is “dimension” to define at least one dimension axis of the MDX query.

Yet further in accordance with at least one embodiment of the present invention, the system additionally comprises an apparatus for generating an MDX query from the clause components by partitioning a set of leaf clause components whose advanced characterization is “measure” into a first “measure” subset and a second “filter” subset, defining a measure axis for the MDX query based on the leaf clause components in the first “measure” subset and defining the leaf clause components in the second “filter” subsets as filters on the at least one dimension axis.

Further in accordance with at least one embodiment of the present invention, the system comprises a hierarchy analyzer operative to analyze at least one leaf clause component of an individual hierarchy and comprising a leaf clause component characterization unit operative to generate an initial characterization of at least one leaf clause component as at least one of a dimension and a measure within a multi-dimensional query definition language; and a cross-analyzer operative to generate an advanced characterization of at least one leaf clause component as exactly one of a dimension and a measure within a multi-dimensional query definition language.

Still further in accordance with at least one embodiment of the present invention, the apparatus for recursively breaking down is operative to break down each “from” clause into a set of at least one clause component including at least one leaf clause component each defining a table within the data storage unit which is associated with the “from” clause, and wherein the cross-analyzer is also operative to characterize each leaf clause component defining a table as either a dimension table or a fact table.

Further in accordance with at least one embodiment of the present invention, the input query is represented as an XML expression.

Still further in accordance with at least one embodiment of the present invention, the input query is represented as an XMLA expression.

Additionally in accordance with at least one embodiment of the present invention, the string of characters comprises an MDX string.

Further in accordance with at least one embodiment of the present invention, the system also comprises a data storage unit operative to store data.

Also provided, in accordance with at least one embodiment of the present invention, is a query processing method operative in conjunction with a data storage unit operative to store data and a query processor operative to accept queries with respect to the data in the data storage unit and to formulate responses to the queries by accessing the data storage unit, the method comprising performing a breakdown analysis of queries thereby to generate a hierarchical representation of each of at least some queries received by the query processor.

Further provided, in accordance with at least one embodiment of the present invention, is a method for performing breakdown analysis of queries on at least one relational data storage unit, the method comprising breaking down an input query on a data storage unit into a set of at least one clause; and recursively breaking down at least one of the plurality of clauses into a set of at least one clause components including defining a hierarchy representing the input query and comprising clauses below the input query and clause components below the clauses, wherein some of the clause components are leaves which are not parents of any other clause component.

Still further in accordance with at least one embodiment of the present invention, the system comprises a query processor operative to accept queries with respect to the data in the data storage unit and to formulate responses to the queries by accessing the data storage unit.

Further in accordance with at least one embodiment of the present invention, the system also comprises a relational database management system including a data storage unit operative to store data; and a query processor operative to accept queries with respect to the data in the data storage unit and to formulate responses to the queries by accessing the data storage unit.

Any suitable processor, display and input means may be used to process, display, store and accept information, including computer programs, in accordance with some or all of the teachings of the present invention, such as but not limited to a conventional personal computer processor, workstation or other programmable device or computer or electronic computing device, either general-purpose or specifically constructed, for processing; a display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices.

The following terms may be construed either in accordance with any definition thereof appearing in the prior art literature or in accordance with the specification, or as follows:
API: Application Program Interface, a language and message format used by an application program to communicate with the operating system or some other control program such as a database management system (DBMS) or communications protocol.
Attribute: Represents the basic abstraction performed on the database table columns. Attribute instances are considered members in a multidimensional environment.
Attribute Relationship: describes relationships of attributes in general using a left and right attribute, a type, cardinality, and whether the attribute relationship determines a functional dependency. The type describes the role of the right attributes with respect to the left attribute. Attributes that are directly related to the hierarchy attributes can be queried as part of the hierarchy, allowing each level of the hierarchy to define attributes that complement the information of a given level.
MDX Axis: parts of MDX statement that comprises or consists of a set of tuples. In Online Analytical Processing (OLAP) cubes define what is represented on its ribs.
OLAP Cube: A very precise definition of an Online Analytical Processing (OLAP) cube that can be delivered using a single SQL statement. The cube defines a cube fact, a list of cube dimensions, and a cube view name that represents the cube in the database.
Data entry: minimal atomic particle of a relational expression. Can be mapped by one to one connection to specific elements in RDBMS.
Data element: minimal non breakable part of a SQL query. Usually field name or table name.
Dimension: defines a set of related attributes and possible joins among the attributes. A dimension captures all attribute relationships that apply on attributes grouped in the dimension and also references all hierarchies that can be used to drive navigation and computation of the dimension.
Dimension table: Table in RDBMS that is mapped into Dimension as defined above.
Facts: A set of measures, Dimensions Foreign Keys, joins and groups related measures that are interesting to a given application. Facts are usually mapped to one or multiple database tables that can be joined to contain all measures in a fact object.
Fact Table: Table in RDBMS that is mapped into FACT as described above.
Hierarchy: Defines navigational and computational means of traversing a given dimension by defining relationships among a set of two or more attributes. Any number of hierarchies can be defined for a dimension. The relationship among the attributes is determined by the hierarchy type.
Join: Represents a relational join that specifies the join type and cardinality expected. A join also specifies a list of left and right Attributes and an operation to be performed.
MDX: Multi Dimensional eXpression—standardized query language for requesting information from an Online Analytical Processing (OLAP) database.
MDX expression: units of syntax that Online Analytical Processing (OLAP) engine can resolve to single (scalar) values or objects. Expressions include functions that return a single value, a set expression, and so on.
MDX Sub cube: limited subset of a multidimensional data in an Online Analytical Processing (OLAP) cube.
MDX statement: set of MDX expressions that can be parsed by MDX parser and executed against an Online Analytical Processing (OLAP) database.
MDX parser: part of an Online Analytical Processing (OLAP) engine that is responsible for converting MDX commands into machine executable code.
Measure: Makes explicit the existence of a measurement entity. For each measure, an aggregation function is defined for computations in the context of a cube model, or cube.
Measures axis: set of measures members that is presented in current query.
Computed member: (or “calculated member”). Computed members are members of a dimension or a measure group that are defined based on a combination of cube data, arithmetic operators, numbers, and functions. For example, a computed member can be created which computes the sum of two physical measures in the cube. Computed member definitions are typically stored in cubes, but their values are computed at query time.
Notation: generally agreed abstract method to represent real entities.
Online Analytical Processing (OLAP) Role: role that relational data entry could have in multidimensional representation.
Rule: statement that comprises or consists of predefined condition and Action item that should be triggered if condition is satisfied.
Rule set: set of rules fathered together based on mutual application field.
Rule-based conversion: Conversion method based on deploying a special set of predefined rules in special order on original expression organized in one notation in order to produce an expression organized in other notation.
Schema: A database design comprised of tables with columns, indexes, constraints, and relationships to other tables. The column specification includes a data type and related parameters such as the precision of a decimal or floating-point number.
Snowflake Schema: A variation of a star schema in which a dimension maps to multiple tables. Some of the dimension tables within the schema join other dimension tables rather than the central fact table creating a long dependency. The remaining dimension tables join directly to the central fact table.
Star Schema: A schema in which all the dimension tables within the schema join directly to the central fact table.
SQL: Structured Query Language, a standardized query language for requesting information from a relational database.
XML: eXtensible Markup Language. A standard format used to describe semi-structured documents and data. During a document authoring stage, XML “tags” are embedded within the informational content of the document. When the XML document is subsequently transmitted between computer systems, the tags are used to parse and interpret the document by the receiving system.
XMLA: special XML dialect used to describe multidimensional structures and entities including multidimensional requests addressed to specific Online Analytical Processing (OLAP) objects.
“Filter” expression: part of MDX statement that limits its results to specific MDX sub cube.
Weak Function Filter: filter expression that is based on a WHERE clause and is characterized in that:
   a. The same table appears in WHERE clause and in GROUPBY clause.
   b. The same field appears in WHERE clause and in SELECT clause of the sub query.
   c. Field in SELECT clause of the sub-query must be without aggregate functions.
Strong Function Filter: a filter expression that is based on WHERE clause, answers to the definition of a Weak Function Filter and has the following characteristics:
   a. The sub Query includes WHERE clause objects.
   b. The SELECT clause returns one value.
“Value Filter”: filter expression that limits subcubes based on measure value.
“Member Filter.”—filter expression that limits subcubes based on dimension or MDX expression based on dimensions.
Leaf clause component: minimal RDBMS expression that cannot be represented as two or more other expressions.
Leaf Clause Component Characterization: Process of defining Online Analytical Processing (OLAP) potential roles for each Leaf Clause Component.
Leaf Clause Component Characterization output: Serializable data structure that includes all results of a Leaf Clause Component Characterization,
Rule-Based Hierarchy Analysis: Process of Leaf Clause Component Characterization output analysis based on relationships between analyzed Leaf Clause Components.
HA rule set: Rule set that support Rule-Based Hierarchy Analysis.
Action items: Action that should be taken in the event that an associated predefined condition is found to be true.
Tuple: an ordered collection of one or more members from dimension hierarchies.
Data storage unit: a body of data which may or may not be stored in a single physical data receptacle.
Relational data storage unit or table: Typically comprises rows, also termed herein “data entries”, columns, also termed herein “fields”, and cells, which are the points of intersection of the rows and columns.
MDX: a multi-dimensional query definition language. In such languages, a query operates on a cube (which has n dimensions where n need not necessarily be 3) within the data structure.

The term “data elements” and “clause components” are used generally synonymously.

### BRIEF DESCRIPTION OF THE DRAWINGS

Certain embodiments of the present invention are illustrated in the following drawings:

FIG. 1 is a simplified functional block diagram illustration of an SQL to MDS conversion system 10 constructed and operative in accordance with certain embodiments of the present invention;

FIG. 2 is a simplified functional block diagram illustration of the SQL query pre-processor of FIG. 1 constructed and operative in accordance with certain embodiments of the present invention;

FIG. 3 is a simplified functional block diagram illustration of the SQL query breaker of FIG. 1 constructed and operative in accordance with certain embodiments of the present invention;

FIG. 4 is a simplified functional block diagram illustration of the leaf clause component characterization functional unit of FIG. 1 constructed and operative in accordance with certain embodiments of the present invention;

FIG. 5 is a simplified functional block diagram illustration of the rule-based hierarchy analyzer 50 of FIG. 1 constructed and operative in accordance with certain embodiments of the present invention;

FIG. 6 is a simplified functional block diagram illustration of the MDX query builder of FIG. 1, constructed and operative in accordance with certain embodiments of the present invention;

FIG. 7 is a simplified flowchart illustration of a method of operation of the SQL query breaker 30 of FIG. 1, the method being operative in accordance with certain embodiments of the present invention;

FIG. 8 is a simplified flowchart illustration of a method for populating a parent-child table, in accordance with certain embodiments of the present invention;

FIGS. 9A-9B, taken together, form a table storing aliases, functions and case expressions, which is an example of the results of performing the method of FIG. 8, for a “select clause”, all in accordance with certain embodiments of the present invention;

FIG. 10 is a table storing table names, join types, table aliases and sub-queries, which constitutes an example of the results of performing the method of FIG. 8, for a “find clause”, all in accordance with certain embodiments of the present invention;

FIGS. 11A-B, taken together, form a table storing fields, operators and sub-queries, which is an example of the results of performing the method of FIG. 8, for a “where clause”, all in accordance with certain embodiments of the present invention;

FIG. 12 is a table storing group items and sub-queries and constituting an example of the results of performing the method of FIG. 8, for a “group-by clause”, all in accordance with certain embodiments of the present invention;

FIG. 13 is a simplified flowchart illustration of a method of operation for the leaf clause component characterization unit of FIG. 1, the method being operative in accordance with certain embodiments of the present invention;

FIG. 14 is a simplified flowchart illustration of a method of operation of the Rule-Based Hierarchy Analyzer of FIG. 1, the method being operative in accordance with certain embodiments of the present invention;

FIG. 15 is a simplified flowchart illustration of a method for performing the “apply Rules from a Hierarchy Analysis rule set” step of FIG. 14, the method being operative in accordance with certain embodiments of the present invention;

FIG. 16 is a simplified flowchart illustration of a method of operation for the MDX query builder of FIG. 6, the method being operative in accordance with certain embodiments of the present invention; and

FIG. 17 is a simplified flowchart illustration of a method for performing the MDX clause building Step of FIG. 16, the method being operative in accordance with certain embodiments of the present invention.

### DETAILED DESCRIPTION OF CERTAIN EMBODIMENTS

One segment of the field of information technology is Online Analytical Processing (OLAP) and Data warehouse querying in general. It is sometimes useful to provide a multidimensional representation of customer submitted relational expressions, e.g. using a system and method capable of converting substantially any relational expression into a probable, preferably a most probable, multidimensional representation. This is useful for fully automated and -managed OLAP meta-data object construction systems based on real customer demands.

The Demand for updated information inside large organizations is increasing on a daily basis, creating difficulties for organizational Business Intelligence Online Analytical Processing (OLAP) teams. One problem that OLAP implementation analysts face is the need for constant meta-data updates. Typically, this problem is resolved by engaging a large number of human OLAP analysts and expert DBAs who, from time to time, update OLAP structures and introduce new entities , updating or deleting existing entities manually. This causes some or all of the following problems:
1. Long response time—long development cycle relative to the short demand cycle. A lengthy process is required for an analyst to identify a need for new information and to incorporate the information into MD-Structures. This information may be needed only during specific times and for a very short time period, such as Fourth of July campaigns, which are only relevant for a short time period, such as 2 weeks, whereas launching a new version of OLAP cubes may require more than 2 months.
2. Quality of Cube—the created cube does not necessarily reflect current information needs even after revision because the needs may not have been properly presented by the information consumer to the human system analyst since these two professionals may not be speaking the same language.
3. Data overhead—OLAP cubes usually contain more data than can be used by the customer. Due to high update related costs, human analysts attempt to produce a cube today, which is predicted to serve the information customer for a long period of time without updates. Inaccurate predictions may result in cubes with large amounts of data that can neither be used nor removed due to the nature of the OLAP system in place.
4. High Costs: For example, a typical OLAP implementation team may comprise 3 specialists who can only handle one business area at a given time. So, a large organization with 7 major business areas, such as HR, Marketing, and Sales etc., may find itself employing 21 human analysts responsible for handling constant updates of OLAP metadata.

One solution involves a process of “copying” the entire Data warehouse into Multidimensional structures, however this does not solve the above problems in their entirety.

Certain embodiments of the present invention seek to provide an automatic system that constantly updates multidimensional metadata according to customer needs and demands. Typically, customers of Business Intelligence (BI) systems stem from middle to senior management of an organization. Demands of these customers can be predicted by analyzing SQL requests sent by business analysts directly or by Data Mining processes. Analysis of such requests tends to expose business entities that have organizational focus. However, such relational expressions usually lack structure and metadata incorporated into the request, making the task of identifying business entities from SQL expressions a very difficult one.

One possible solution is to convert poorly structured SQL expressions to well structured MDX expressions, using a system and associated method for quickly, efficiently, and automatically creating an MDX representation of any customer-submitted SQL request.

According to certain embodiments of the present invention, a system, a computer program product, and an associated method are provided for automatic conversion of SQL statements into a set of MDX expressions or MDX statements. The system automatically creates multidimensional representation of SQL requests sent to a relational database management system. An SQL statement could be represented as a direct SQL request to system, as an SQL request submitted to relational database engine or as a request generated by application server in the form of a string expression contained SQL statement, an XML expression comprising or consisting of SQL statements or any other form of SQL statements that may be submitted to any relational database management system engine.

The output of the system typically comprises well-formatted and documented multidimensional expression in the form of strings, XML or XMLA expressions. This system need not generate OLAP DDL expressions nor create OLAP Meta data for an entire cube. The system may produce a probable, e.g. most probable, MDX expression that represents a single input SQL statement.

The present system may deconstruct or parse the SQL statement into major objects related to relevant SQL clauses and then define each data element in that statement as an element of these objects. These elements may be managed by a container manager system that enables a Rule-Maker to deploy rule-based conversion.

Rule-based conversion typically comprises producing multidimensional representations for relational expressions, and, optionally, a Role-Report listing objects comprising relational entities and their respective multidimensional roles. This object may be managed by the Role-report manager that enables the last part of the system to construct possible MDX expressions. Typically a rule-based method is employed which predicts a most probable MDX statement from a collection of possible MDX statements recognized by the system.

The output of the system typically comprises the most probable MDX representation of the input.

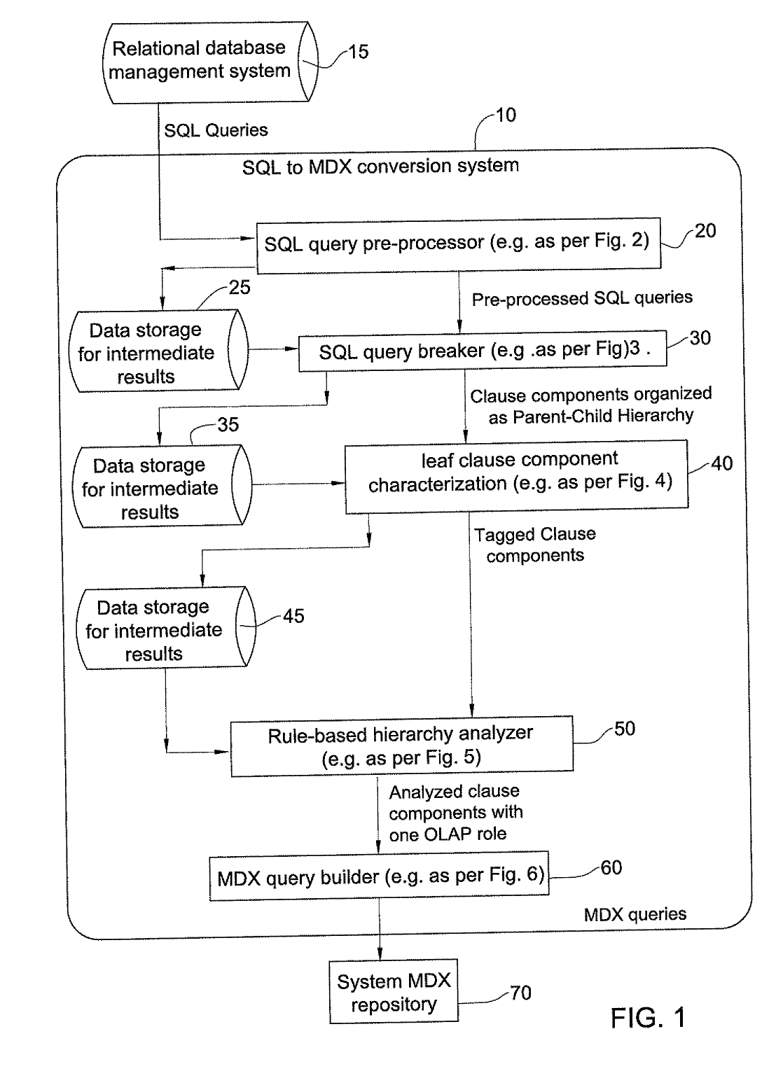

Reference is now made to FIG. 1 which is a simplified functional block diagram illustration of an SQL to MDS conversion system 10 constructed and operative in accordance with certain embodiments of the present invention.

As shown, the SQL to MDS conversion system 10 of FIG. 1 receives SQL queries from a conventional relational database management system 15 such as an SQL Server System or a Teradata system, typically including a data storage unit and a query processor.

To connect to the database management system 15 the following method may be employed:

1. Start query logging application; e.g. for SQL-Server—start Profiler; for Teradata—run “Start query logging” command
2. Read log from log tables e.g. for SQL-Server system: select count(*) from ::fn_trace_getinfo (default)

For Teradata system:
select * from DBQLogTbl inner join DBQLSqlTbl on dbqlsqltbl.ProcID=dbqlogtbl.ProcID and dbqlsqltbl.QueryID=dbqlogtbl.QuerylD
   3. Record all queries for temporary storage on system's storage facility.

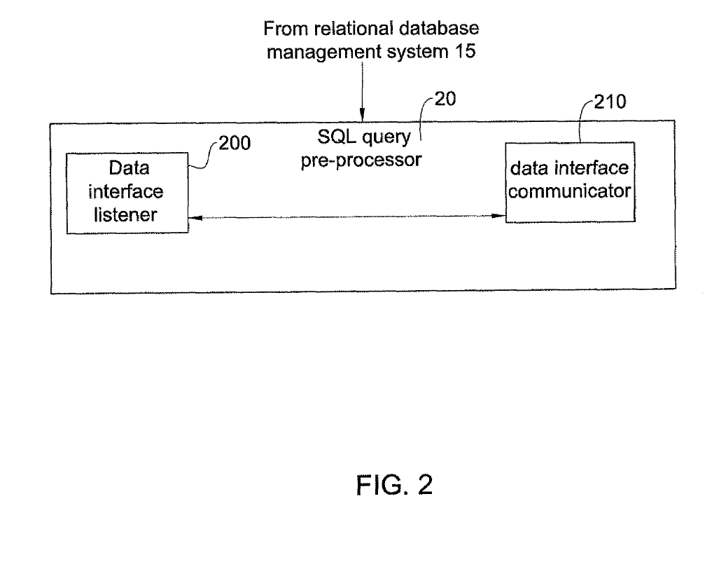

The SQL to MDS conversion system 10 typically includes an SQL query pre-processor 20 including a data interface for pre-processing SQL queries typically collected from relational database management system 10. One possible implementation of the SQL query pre-processor 20 is described in detail below with reference to FIG. 2.

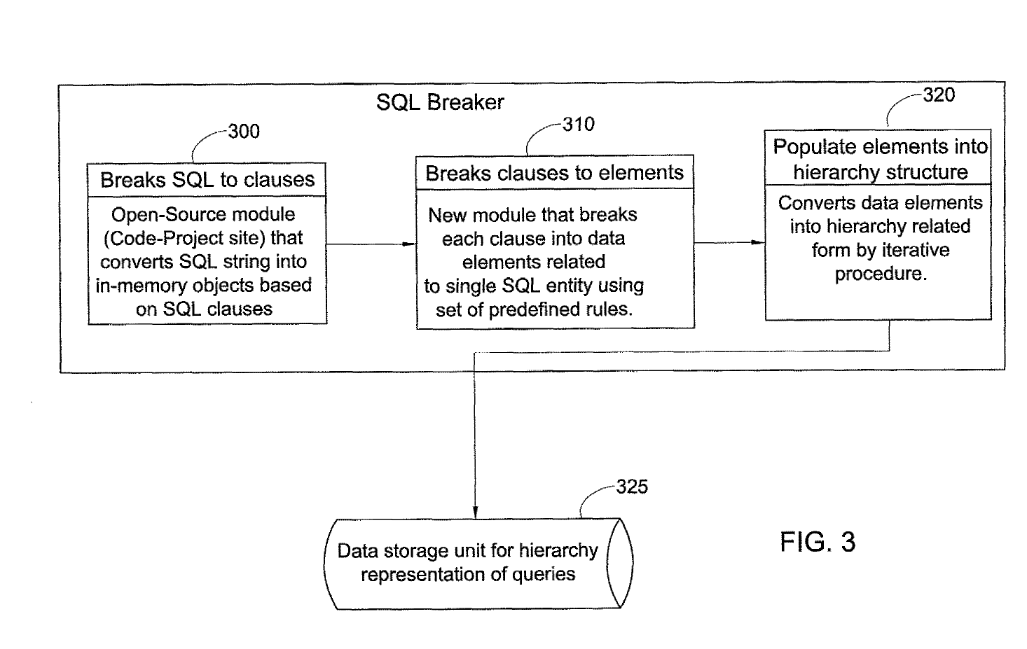

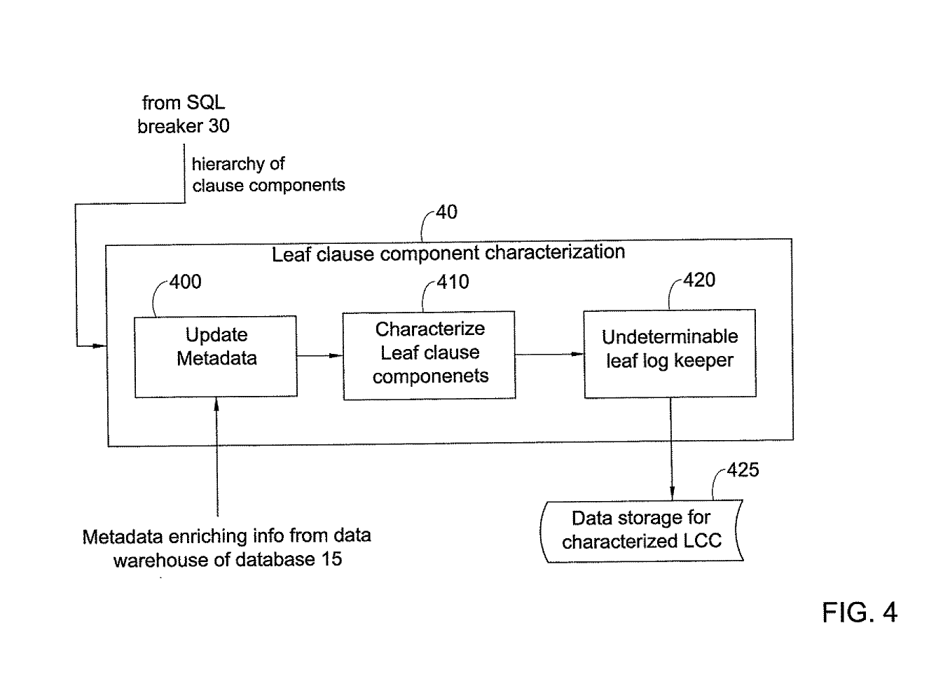

The pre-processed SQL queries provided by the pre-processor 20 are typically fed to an SQL query breaker 30 which is operative to break up some, or typically each, of the pre-processed SQL queries into clause components and represent each such query as a parent-child hierarchy of clause components including leaves, e.g. as described below in detail with reference to FIG. 3. The parent-child hierarchy of clause components identified by the SQL query breaker 30 is typically provided to a leaf clause component characterization functional unit 40 which is operative to characterize each leaf clause component by identifying all possible Online Analytical Processing (OLAP) rules for each clause component which is a leaf in the parent-child hierarchy. One possible implementation of the leaf clause component characterization functional unit 40 is described in detail below with reference to FIG. 4.

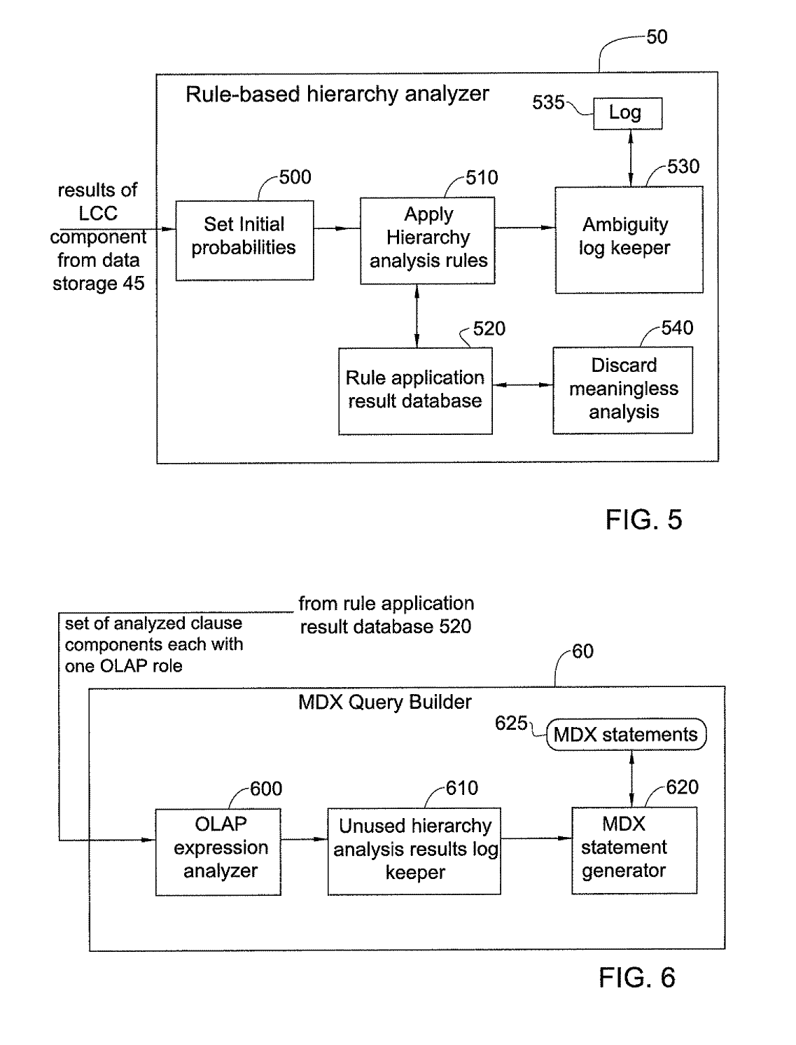

The output of the leaf clause component characterization functional unit 40 typically includes tagged clause components for each component found by module 30. The tagged clause components are fed to a rule-based hierarchy analyzer 50. The rule-based hierarchy analyzer 50 typically filters and completes the tagged clause components, including defining exactly one Online Analytical Processing (OLAP) role for each. One possible implementation of the rule-based hierarchy analyzer 50 is described in detail below with reference to FIG. 5.

The rule-based hierarchy analyzer 50 typically provides a set of analyzed clause components, each typically associated with a single Online Analytical Processing (OLAP) rule, to an MDX query builder 60 which builds MDX queries from the analyzed clause components. One possible implementation of the MDX query builder 60 is described in detail below with reference to FIG. 6. The MDX queries generated by the MDX query builder 60 may be stored, for example, in a suitable system MDX repository 70.

It is appreciated that typically, all components get tags whereas only leaves get OLAP Roles, where the term “Leaf component” refers to a component that has one immediate ancestor component and no descendant components in a PC hierarchy, of data elements e.g. clause components, created by SQL Breaker 30. Generally, in the description above, the term “data element” refers to a clause component.

Example embodiments of functional units 20-60 of FIG. 1 are now described in detail with reference to FIGS. 2-6.

FIG. 2 is a simplified functional block diagram illustration of the SQL query pre-processor 20 of FIG. 1 constructed and operative in accordance with certain embodiments of the present invention.

Pre-processor 20 typically comprises a module responsible for initial query processing. The pre-processor typically includes a Data Interface listener 200 which is a sub-module that enables connection to relational query storage units. The pre-processor also includes a data interface communicator 210 which is a module that filters, orders and transmits relevant queries to SQL breaker module 30 of FIG. 1. The data interface listener 200 is typically different for and adapted to each individual RDBMS system, e.g. as described in the RDBMS vendor manual for DBA. The data interface communicator 210 is typically an integral part of the system and is typically uniform over different RDBMS systems, operative to filter only data returning queries and transfer only these to downstream modules in the apparatus of FIG. 1.

A C# designed dll module may be used to read queries for an SQL Server and to generate links by reflection to other portions of code. Additional modules have since been developed for Teradata and Oracle and because of reflection, transition from one to another is within the level of capability of an ordinarily skilled man of the art.

As shown, the SQL query pre-processor 20 typically comprises a data interface listener 200 interacting with a data interface communicator 210. The listener 200 listens to the relational database management system 15 of FIG. 1 and to a MDDBMS (Multi-dimensional data base management system) and brings in new SQL and/or MDX statements to break. The data interface communicator 210 establishes connections between a data listener that contains query log and the SQL breaker 30 of FIG. 1.

FIG. 3 is a simplified functional block diagram illustration of the SQL query breaker 30 of FIG. 1 constructed and operative in accordance with certain embodiments of the present invention. The SQL query breaker 30 is typically operative to break down an SQL query into a connected hierarchical structure comprising interconnected clause components. Typically, the SQL breaker 30 may be an open-source module e.g. “Open SQL Parser” (http://sourceforge.net/projects/osqlp/), third party commercial component e.g. “General SQL Parser” (http://www.sqlparser.com/), or proprietary developed module, built according to RDBMS specifications as supplied by RDBMS vendors.

Typically the SQL query breaker 30 employs top-down parsing, which is a strategy of analyzing unknown data relationships by hypothesizing general parse tree structures and then considering whether the known fundamental structures are compatible with the hypothesis. Use of top-down parsing is known, e.g. in analysis of natural languages and of computer languages. Top-down parsing can be viewed as an attempt to find left-most derivations of an input-stream by searching for parse-trees using a top-down expansion of the given formal grammar rules. Tokens are consumed from left to right. Inclusive choice is used to accommodate ambiguity by expanding all alternative right-hand-sides of grammar rules, e.g. as described in the following publication; Aho, A. V., Sethi, R. and Ullman, J. D. (1986) Compilers: principles techniques, and tools, Addison-Wesley Longman, Boston, Mass., USA. One suitable device for performing top-down parsing is a “recursive descent parser” which is a top-down parser built from a set of mutually-recursive procedures, or a non-recursive equivalent where each such procedure typically implements one of the production rules of the grammar. Thus the structure of the resulting program closely mirrors that of the grammar it recognizes.

As shown, the SQL query breaker 30 is a typical implementation of this kind of parser, comprises a chain of functional units, including a query-to-clause breaker 300 operative to break down pre-processed SQL queries into clauses, a clause-to-element breaker 310 operative to break down clauses into elements, and a hierarchy generator 320 operative to populate the elements generated by clause-to-element breaker 310, into a parent-child hierarchy. It converts an SQL string received from the SQL query preprocessor 20 into one or more in-memory objects based on SQL clauses. The clause-to-element breaker 310 then breaks down some of, or typically each, clause identified by module 300 into data elements related to a single SQL entity, using a set of pre-defined rules. Finally, the hierarchy generator 320 converts some of, or typically each, data element identified by module 310, into hierarchy form, using an iterative process e.g. using a Top-Down parsing strategy as described earlier.

FIG. 4 is a simplified functional block diagram illustration of the leaf clause component characterization unit 40 of FIG. 1 constructed and operative in accordance with certain embodiments of the present invention. As shown, the unit 40, which typically receives a hierarchy of clause components from SQL breaker 30, typically comprises a chain of functional units including a metadata updating module 400, a leaf clause component characterization module 410 and an undeterminable leaf log keeper 410. Typically, the metadata updating module 400 accesses the source database 15, typically the data warehouse thereof, to find information which call be used to enrich leaf clause component metadata. It is appreciated that initial, typically incomplete, metadata is incorporated into a query, e.g. fields' names or tables' names. The Metadata updating module 400 typically completes this metadata to full qualification level, a process which is termed herein “enrichment”.

Leaf clause component characterization module 410 then characterizes each leaf with at least one Online Analytical Processing (OLAP) rule. Undeterminable leaf log keeper 410 keeps a first error log storing an indication of each leaf which module 410 failed to associate with an Online Analytical Processing (OLAP) rule. Typically, indications of each such leaf's parents are also stored. Undeterminable leaf log keeper 410 typically supplies “tagged clause components to the “set initial probabilities” module 500 of FIG. 5, described below.

FIG. 5 is a simplified functional block diagram illustration of the rule-based hierarchy analyzer 50 of FIG. 1 constructed and operative in accordance with certain embodiments of the present invention. As shown, the rule-based hierarchy analyzer 50 of FIG. 1 typically includes a module 500 for setting system-administrator-determined initial probabilities. Each output of the leaf clause component characterization unit 40 of FIG. 1 has an OLAP role. Rule-based hierarchy analyzer 50 assumes that this role is not deterministic but stochastic, as defined by an associated initial probability parameter, which, as aforesaid is typically set by a system administrator.

The rule-based hierarchy analyzer 50 of FIG. 1 also typically includes a hierarchy analysis rule set applicator 510 operative to apply rules from a hierarchy analysis rule set, e.g. some or all of the hierarchy analysis rules in the example hierarchy analysis rule set described below, and to store the results of the rule application process in a rule application result database 520.

The objective of the rule application process performed by functional unit 510 is to differentiate Online Analytical Processing (OLAP) roles for the various leaf clause components. If Online Analytical Processing (OLAP) roles cannot be differentiated for certain leaf clause components, these leaf clause components, and typically their parents in the hierarchy, are reported to a second error log by an ambiguity log keeper 530. Typically, meaningless analysis is discarded by a functional unit 540 so as to reduce or eliminate useless data in rule application result database 520.

FIG. 6 is a simplified functional block diagram illustration of the MDX query builder 60 of FIG. 1, constructed and operative in accordance with certain embodiments of the present invention. As shown, the MDX query builder 60 typically comprises a chain of functional units, including an Online Analytical Processing (OLAP) expression analyzer 600, an unused hierarchy result log keeper 610, and an MDX statement generator 620. The OLAP expression analyzer 600 receives the set of analyzed clause components, each associated with a single Online Analytical Processing (OLAP) role, from the rule application result database 520 of FIG. 5 and runs an MDX rule set over each, thereby to generate MDX expressions. Typically, different rule sets are used for each of modules 30, 40 and 50. Examples of rules are provided below. The unused hierarchy result log keeper 610 reports any unused hierarchy analysis results as errors; these errors are stored in a third log. MDX statement generator 620 constructs MDX statements (MDX queries) from the MDX expressions generated by module 600.

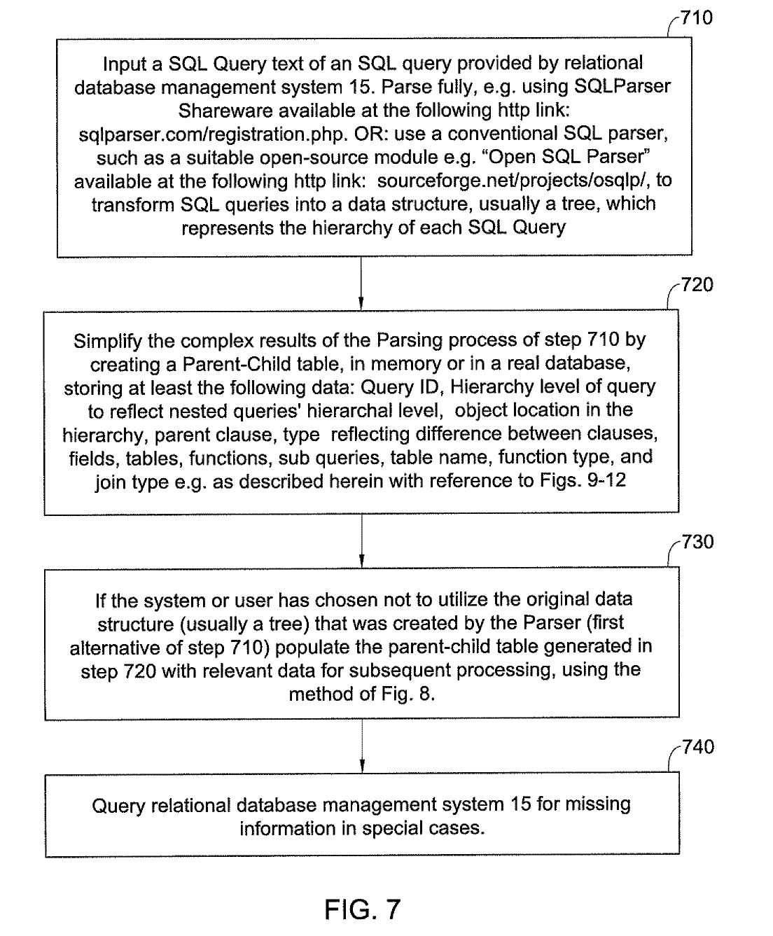

FIG. 7 is a simplified flowchart illustration of a method of operation of the SQL query breaker 30 of FIG. 1, the method being operative in accordance with certain embodiments of the present invention. The method of FIG. 7 typically comprises some or all of the following steps, suitably ordered e.g. as shown:

In Step 710, according to a first alternative, input a SQL Query text of an SQL query provided by relational database management system 15. Parse fully, e.g. using SQLParser Shareware available at the following http link: sqlparser.com/registration.php. According to a second alternative, use a conventional. SQL parser, such as a suitable open-source module e.g. “Open SQL Parser” available at the following http link: sourceforge.net/projects/osqlp/, to transform SQL queries into a data structure, usually a tree, which represents the hierarchy of each SQL Query.

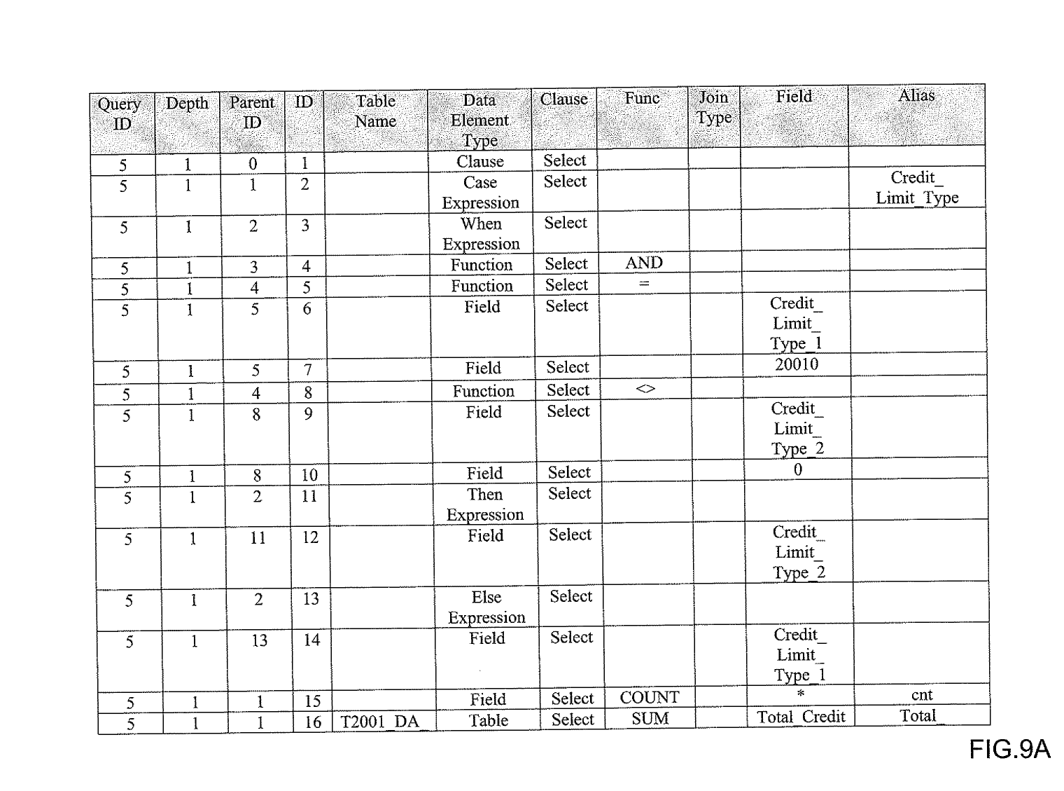

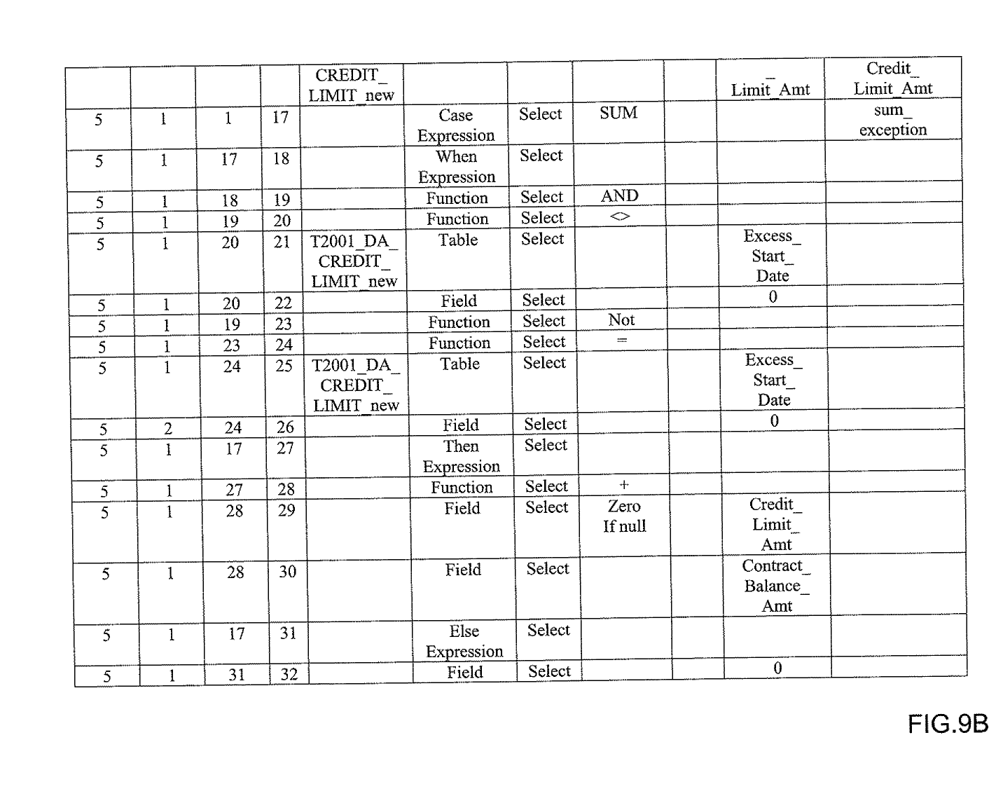

In Step 720, simplify the complex results of the Parsing process of step 710 by creating a Parent-Child table, in memory or in a real database, storing at least the following data: Query ID, Hierarchy level of query to reflect nested queries' hierarchal level, object location in the hierarchy, parent clause, type reflecting deference between clauses, fields, tables, functions, sub queries, table name, function type, and join type e.g. as described herein with reference to FIGS. 9-12.

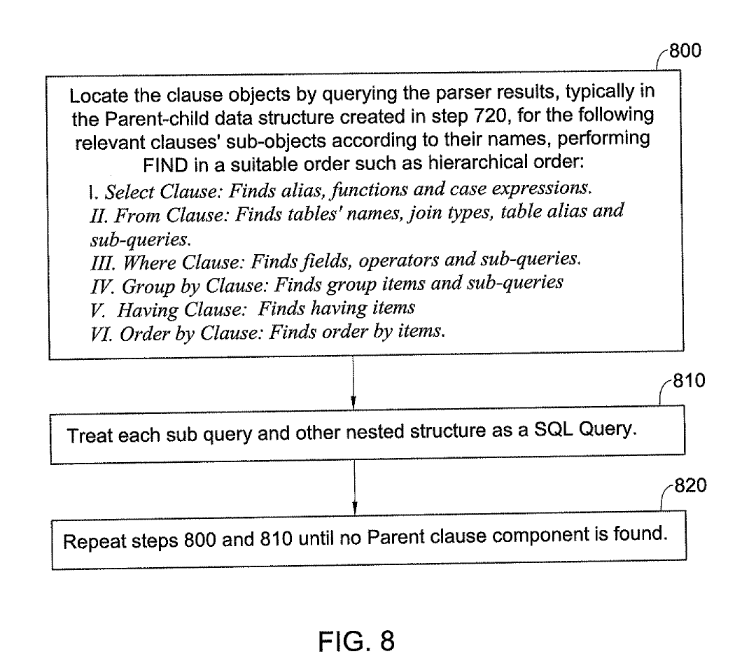

In Step 730, if the system or user has chosen not to utilize the original data structure (usually a tree) that was created by the Parser (first alternative of step 710), populate the parent-child table generated in step 720 with relevant data for subsequent processing, using the method of FIG. 8.

In Step 740, Query relational database management system 15 for missing information in special cases. For example, in SELECT *, query for missing column names.

The following command, to ‘Create ‘TBL_Breaker’ table in a database, is suitable for implementing step 720 of FIG. 7:

IF NOT EXISTS (SELECT * FROM sys.tables WHERE name=‘TBL_Breaker’) CREATE TABLE TBL_Breaker(QueryId int NULL, Depth int NULL,Parent_Id int NULL,Id int NULL,DataElement_Name nvarchar(200) NULL,DataElement_Type nvarchar(50) NULL,Clause nvarchar(50) NULL,func nvarchar(50) NULL,Join_Type nvarchar(50) NULL,Field nvarchar(200) NULL,Alias nvarchar(50) NULL)

The method of FIG. 8 typically comprises some or all of the following steps, suitably ordered e.g. as shown:

In step 800, locate the clause objects by querying the parser results, typically in the parent-child data structure created in step 720, for the following relevant clauses' sub-objects according to their names, performing FIND in a suitable order such as hierarchical order:
i. Select Clause: Finds alias, functions and case expressions.
ii. From Clause: Finds tables' names, join types, table alias and sub-queries.
iii. Where Clause: Finds fields, operators and sub-queries.
iv. Group by Clause: Finds group items and sub-queries.
v. Having Clause: Finds having items.
vi. Order by Clause: Finds order by items.

In step 810, treat each sub query and other nested structure as a SQL Query.

In step 820, repeat steps 800 and 810 until no parent clause component is found.

### Example 1

The operation of the method of FIGS. 7-8 for an example SQL query is now described. An example of an SQL Query text which may serve as input to step 710 of FIG. 7 is as follows:

```
Select
Case When Credit_Limit_Type_1=20010 And Credit_Limit_Type_2<>0
        Then Credit_Limit_Type_2
        Else Credit_Limit_Type_1
        End As Credit_Limit_Type,
Count (*) As cnt,
Sum (t2001.Total_Credit_Limit_Amt) As Total_Credit_Limit_Amt,
Sum (Case When T2001.Excess_Start_Date<>0 And Not T2001.Excess_Start_Date
=0
            Then zeroifnull (Credit_Limit_Amt) +Contract_Balance_Amt
              Else 0
              End
    ) As sum_exception
From dwd1_view.T2001_DDA_CREDIT_LIMIT_new T2001,
dwp1_view.GC01_Account GC01,
  dwp1_view.T8300_CONTRACT_DDA_d0 T8300
Where GC01.account_id=T2001.account_id And
GC01.account_id=T8300.account_id And active_account_ind=‘A’ And
Substr(GC01.account_id,1,3)=912 and Substr(GC01.account_id,8,1) Not In (7,8)
And GC01.account_id Not in ( Select account_id
                                        From
dwp1_ram_view.T0120_Acct_Attribute_Calculate
                                        where Acct_Customer_Type_Code In
(4,7,9,16,17,20,27,28)
                                      )
And wing_id=‘12’ Group By Credit_Limit_Type, Branch
```

The table formed by FIGS. 9A-9B, taken together, storing aliases, functions and (in “data element type” column) case expressions, is an example of the results of performing the method of FIG. 8, for the “select clause” above.

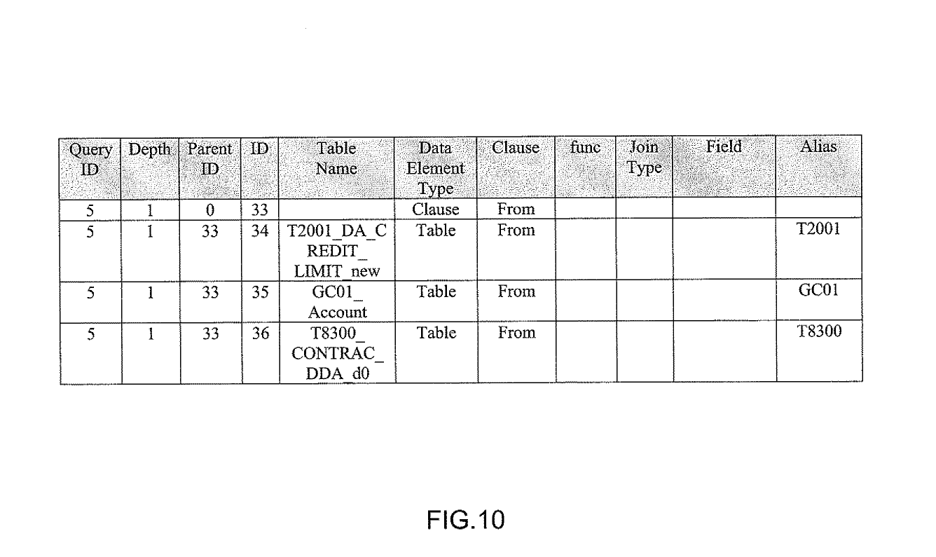

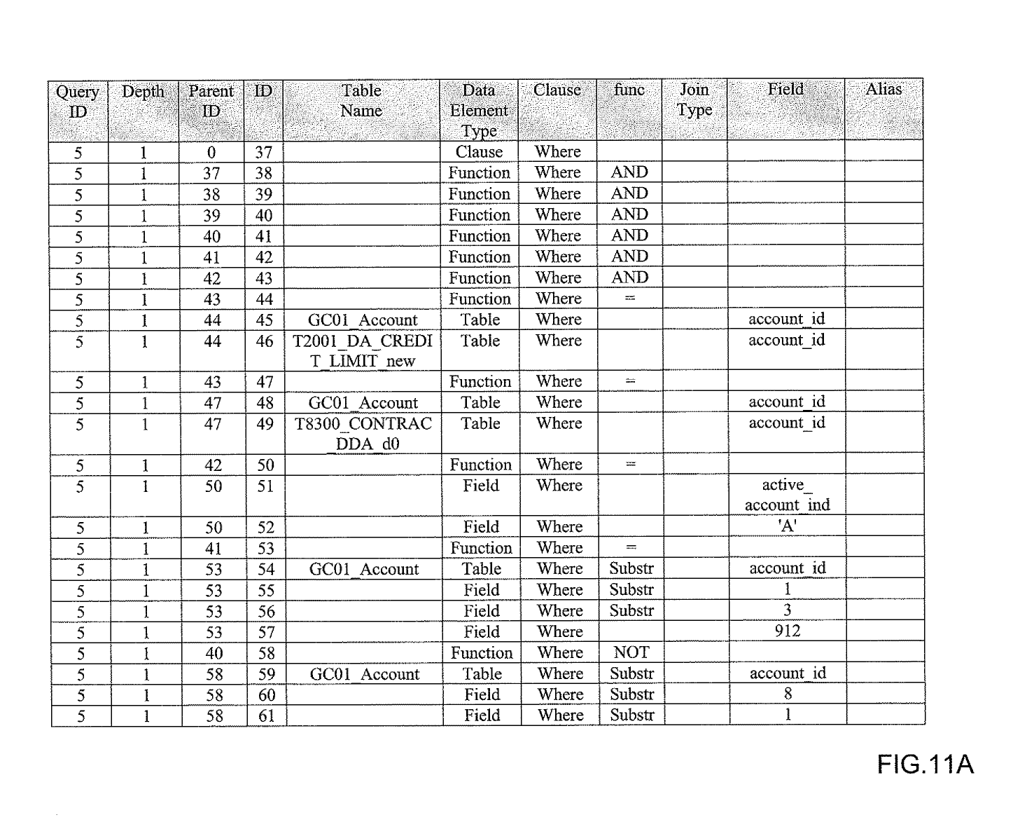

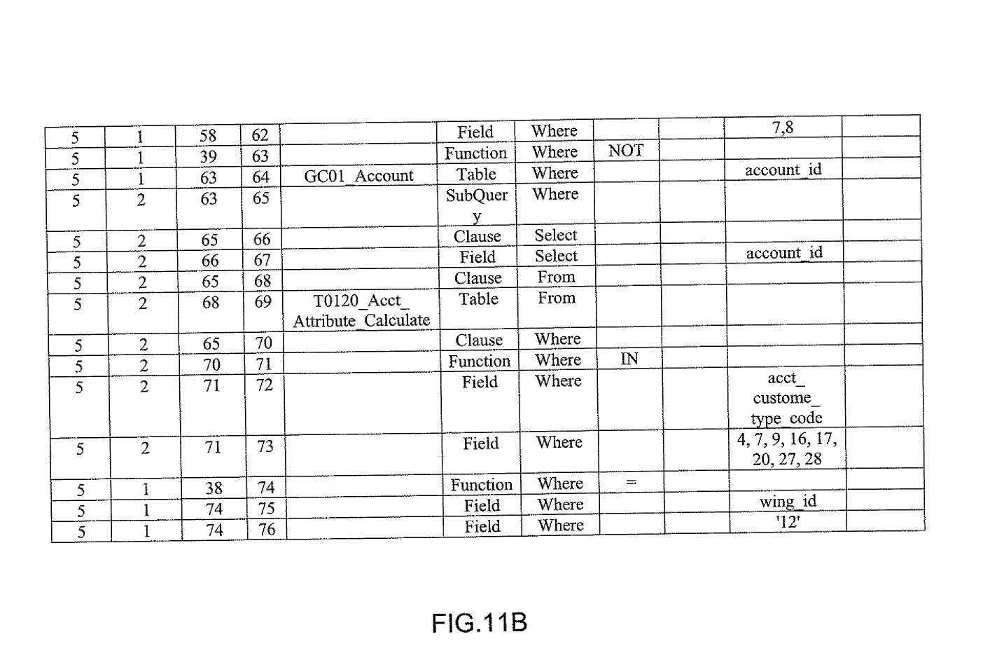

The table of FIG. 10, storing table names, join types, table aliases (e.g. in FIGS. 9A-9B) and sub-queries (e.g. in FIG. 11B), is an example of the results of performing the method of FIG. 8, for the “find clause” above.

The table formed by FIGS. 11A-11B, taken together, storing fields, operators and sub-queries, is an example of the results of performing the method of FIG. 8, for the “where clause” above.

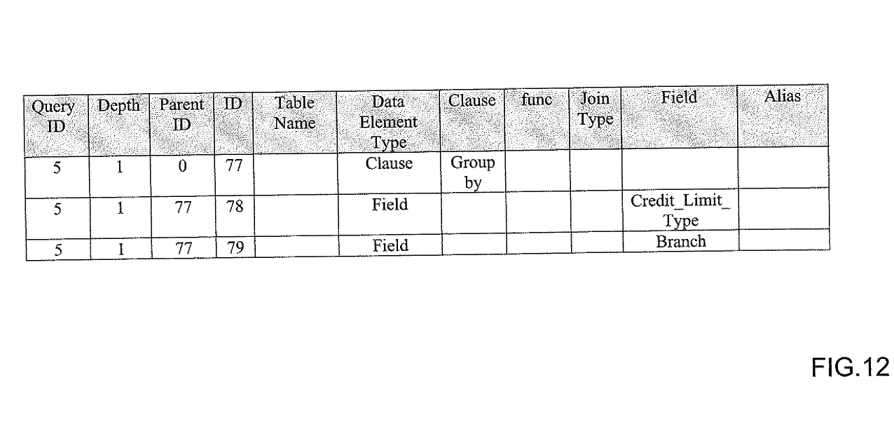

The table of FIG. 12, storing group by items, is an example of the results of performing the method of FIG. 8, for the “group-by clause” above.

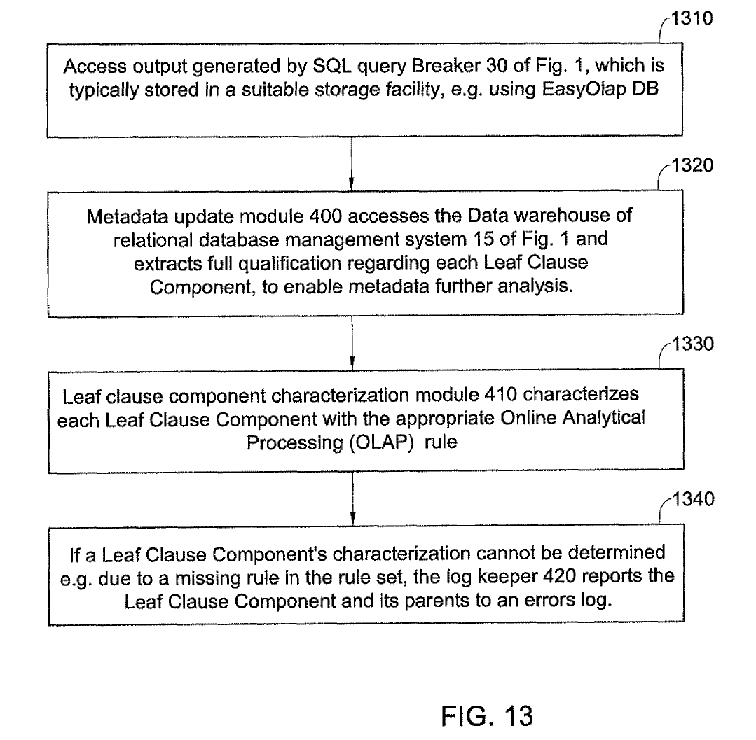

FIG. 13 is a simplified flowchart illustration of a method of operation for the leaf clause component characterization unit 40 of FIG. 1. The method of FIG. 13 typically comprises some or all of the following steps, suitably ordered e.g. as shown:

In step 1310, access output generated by SQL query Breaker 30 of FIG. 1, which is typically stored in a suitable storage facility.

In Step 1320, metadata update module 400 may access the Data warehouse of relational database management system 15 of FIG. 1 and extract full qualification regarding each Leaf Clause Component, to enable metadata for further analysis purpose. For example, when the Leaf Clause Component is a field named “Credit_Limit_Type_{—}1”, go to the DB systems table in relational database management system 15 and locate the table name that “Credit_Limit_Type_{—}1” is part of. For example, run the following query on Teradata “Select Tablename from DBC.Columns, where ColumnName=‘Credit_Limit_Type_{—}1’ and TableName in:
(‘dwd1_view.T2001_DDA_CREDIT_LIMIT_new’, ‘dwp1_view.GC01_Account’, ‘dwp1_view.T8300_CONTRACT_DDA_d0’).

In step 1330, leaf clause component characterization module 410 may characterize each Leaf Clause Component with the appropriate Online Analytical Processing (OLAP) rule. For example, associate “dimension” to field “Credit_Limit_Type_{—}1”. This may be effected by applying Rules from a Leaf Clause Component characterization rule set, an example of which is described below, and storing the results in any suitable data storage facility. To do this, read a Rule from rule-set list in a suitable order, such that all rules are eventually applied. Apply each such rule to the output of the SQL query breaker 30 of FIG. 1, which results may be stored in suitable tables such as the tables of FIGS. 9A-12. If the condition described in the rule is applicable, store appropriate characterization into an appropriate structure in an appropriate data storage facility. For example, if the rule is “a field that was originally located on a GroupBy clause then Result of this query is a list of dimension members”, write “Dimension” in a Table named “TBL_ContentRules”.

There may a case in which a Leaf Clause Component's characterization cannot be determined e.g. due to a missing rule in the rule set. If so, in step 1340, the log keeper 420 may report the Leaf Clause Component and its parents to an errors log.

For example, execute following SQL statement: “Insert into ErrorLog Values <Unrecognized Expression>”, where <Unrecognized Expression> stands for a clause component for which no Online Analytical Processing (OLAP) role could be determined.
A suitable Leaf Clause Component characterization Rule Set which may be used by Leaf Clause Component characterization unit 410 of FIG. 4 when performing step 1330 of FIG. 13 may include the following rules:

Leaf Clause Component characterization Rule 1: Any field in a SELECT clause with an aggregate function on it constitutes a Measure.

Leaf Clause Component characterization Rule 2: All non-aggregate fields in a SELECT clause may be member properties of dimensions.

Leaf Clause Component characterization Rule 3: Any table in a FROM object clause may be a Fact table or a Dimension table. A Fact table defines a Measures group and a Dimension table defines a Dimension.

Leaf Clause Component characterization Rule 4: Any field in a GROUPBY clause indicates a dimension level.

Leaf Clause Component characterization Rule 5: Any field in: “When”, “Then”, “Else” parts in a “Case” expression can be measure or member properties of Dimensions.

Leaf Clause Component characterization Rule 6: Any filter based on one field and value, whether a mathematical or a textual expression, in a WHERE clause, may be a “Value Filter” or “Member Filter”.

Alternatively, any other rule set which characterizes each Leaf Clause Component object may be used. Rules maybe defined in any algorithm notation or language. Some of the rules may yield ambiguous results which are typically disambiguated at least partially, using subsequent cross analysis, also termed herein “Hierarchy Analysis”.

### Example 2

The following is an example of use of the above Rule Set for Leaf Clause Component characterization unit 410. The example uses SQL language to query stored output of the SQL Query Breaker 30 of FIG. 1 when an RDBMS is used to facilitate the Leaf Clause Component and its appropriate characterizations. The returning answer set comprises the set of fields which match the rule's characterization.

Use of Leaf Clause characterization Rule 1 (Any field in a SELECT clause with an aggregate function on it is a measure):

SELECT [field]
FROM [EasyOlap].[dbo].[TBL_Breaker] ‘Storage table for LCC and
Carecterization’
WHERE [Clause]=‘Select’ and [func] in (SUM, AVG, MIN, MAX,
AVG) and Field!=‘’ and Parent_Id=(SELECT id FROM
[EasyOlap].[dbo].[TBL_Breaker]
WHERE [Clause]=‘Select’ and DataElement_Type=‘Clause’)

Use of Leaf Clause characterization Rule 2 (All non-aggregate fields in a SELECT clause may be member properties of a dimension):

```
SELECT [field]
FROM [EasyOlap].[dbo].[TBL_Breaker]
WHERE [Clause]=‘Select’ and [func]not in (SUM, AVG, MIN, MAX,
AVG) and [DataElement_Type]!=‘Clause’ and
DataElement_Type!=‘Case Expression’
    and Parent_Id=( SELECT id
            FROM [EasyOlap].[dbo].[TBL_Breaker]
            WHERE [Clause]=‘Select’ and
            [DataElement_Type]=‘Clause’)
```

Use of Leaf Clause characterization Rule 3 (Any table in a FROM object clause may be a Fact or Dimension table, the former defining a Measures group and the latter defining a Dimension):

SELECT DISTINCT DataElement_Name, “FACT table”
FROM [EasyOlap].[dbo].[TBL_Breaker]
WHERE [Clause]=‘From’ and [DataElement_Type]=‘Table’
UNION
SELECT DISTINCT DataElement_Name , “Dimension table”
FROM [EasyOlap].[dbo].[TBL_Breaker]
WHERE [Clause]=‘From’ and [DataElement_Type]=‘Table’

Use of Leaf Clause characterization Rule 4 (Any field in a GROUPBY clause indicates a dimension level):

SELECT *
FROM [EasyOlap].[dbo].[TBL_Breaker]
WHERE [Clause]=‘GROUPBY’ and ([DataElement_Type]=‘Field’ or
[DataElement_Type]=‘Table’) and QueryId = 1 and Dept = 1

Use of Leaf Clause characterization Rule 5 (Any field in: “When”, “Then”, “Else” parts in “Case” expression can be measure or member properties of Dimensions):

```
WITH DirectReports([QueryId],[UserName] ,[Host],[ExecStartTime],
  [Depth],[Parent_Id],[Id],[DataElement_Name] ,[DataElement_Type],
  [Clause],[func],[Join_Type] ,[Field],[Alias])
AS (SELECT [QueryId],[UserName],[Host]
,[ExecStartTime],[Depth],[Parent_Id],
      [Id],[DataElement_Name],[DataElement_Type],[Clause],[func],
      [Join_Type],[Field],[Alias]
  FROM dbo.TBL_Breaker
  WHERE [Id] in (SELECT id
            FROM dbo.TBL_Breaker
            WHERE Clause=‘select’ and DataElement_Type =‘When
            Expression’ and QueryId = 1 and Depth = 1
            )
  and QueryId = 1 and Depth = 1
  union all
  SELECT t1.[QueryId],t1 .[UserName],t1.[Host], t1.[ExecStartTime],
      t1.[Depth] ,t1.[Parent_Id],t1.[Id],t1.[DataElement_Name],
      t1.[DataElement_Type],t1.[Clause], t1.[func],t1.[Join_Type],
      t1.[Field],t1.[Alias]
  FROM dbo.TBL_Breaker t1
  inner join DirectReports dr
  on t1.parent_id=dr.id and t1.QueryId=dr.QueryId
  )
SELECT t1.*,t2.func as subFunc
FROM (SELECT [QueryId],[UserName],[Host]
,[ExecStartTime],[Depth],[Parent_Id]
    ,[Id],[DataElement_Name]
,[DataElement_Type],[Clause,[func],[Join_Type]
    ,[Field],[Alias]
    FROM DirectReports
    WHERE QueryId = 1 and Depth = 1
  ) t1
  inner join
  (SELECT [QueryId],[UserName],[Host]
,[ExecStartTime],[Depth],[Parent_Id]
        ,[Id],[DataElement_Name] ,[DataElement_Type] ,[Clause] ,
        [func],[Join_Type] ,[Field],[Alias]
    FROM DirectReports
  )t2
  on t1.parent_id=t2. id
WHERE t1.DataElement_Type!=‘function’ and t1.QueryId = 1and
t1.Depth = 1
union
SELECT t4.* ,t4.func as subFunc
FROM dbo.TBL_Breaker t4
WHERE Clause=‘select’ and DataElement_Type=‘When Expression’ and
t4.QueryId = 1and t4.Depth = 1
union
SELECT t5.*,t5.func as subFunc
FROM dbo.TBL_Breaker t5
WHERE t5.id in (SELECT parent_id
          FROM dbo.TBL_Breaker
          WHERE Clause=‘select’ and DataElement_Type=‘When
          Expression’)
  and t5.QueryId = 1and t5.Depth = 1
Order By Id
Then Expression
WITH DirectReports([QueryId],[UserName] ,[Host],[ExecStartTime],
  [Depth],[Parent_Id],[Id],[DataElement_Name] ,[DataElement_Type],
  [Clause],[func],[Join_Type] ,[Field],[Alias])
AS (SELECT [QueryId],[UserName],[Host]
,[ExecStartTime],[Depth],[Parent_Id],
      [Id],[DataElement_Name],[DataElement_Type],[Clause],[func],
      [Join_Type],[Field],[Alias]
  FROM dbo.TBL_Breaker
  WHERE [Id] in (SELECT id
            FROM dbo.TBL_Breaker
            WHERE Clause=‘select’ and DataElement_Type =‘Then
            Expression’ and QueryId = 1 and Depth = 1
            )
  and QueryId = 1 and Depth = 1
  union all
  SELECT t1.[QueryId],t1 .[UserName],t1.[Host], t1.[ExecStartTime],
      t1.[Depth] ,t1.[Parent_Id],t1.[Id],t1.[DataElement_Name],
      t1.[DataElement_Type],t1.[Clause] , t1.[func],t1.[Join_Type],
      t1.[Field],t1.[Alias]
  FROM dbo.TBL_Breaker t1
  inner join DirectReports dr
  on t1.parent_id=dr.id and t1.QueryId=dr.QueryId
  )
SELECT t1.*,t2.func as subFunc
FROM (SELECT [QueryId],[UserName],[Host]
,[ExecStartTime],[Depth],[Parent_Id]
    ,[Id],[DataElement_Name]
,[DataElement_Type],[Clause,[func],[Join_Type]
    ,[Field],[Alias]
    FROM DirectReports
    WHERE QueryId = 1 and Depth = 1
  ) t1
  inner join
  (SELECT [QueryId],[UserName],[Host]
,[ExecStartTime],[Depth],[Parent_Id]
      ,[Id],[DataElement_Name] ,[DataElement_Type] ,[Clause] ,
      [func],[Join_Type] ,[Field],[Alias]
    FROM DirectReports
  )t2
  on t1.parent_id=t2. id
WHERE t1.DataElement_Type!=‘function’ and t1.QueryId = 1and
t1.Depth = 1
union
SELECT t4.* ,t4.func as subFunc
FROM dbo.TBL_Breaker t4
WHERE Clause=‘select’ and DataElement_Type=‘Then Expression’ and
t4.QueryId = 1and t4.Depth = 1
union
SELECT t5.*,t5.func as subFunc
FROM dbo.TBL_Breaker t5
WHERE t5.id in (SELECT parent_id
          FROM dbo.TBL_Breaker
          WHERE Clause=‘select’ and DataElement_Type=‘Then
          Expression’)
    and t5.QueryId = 1and t5.Depth = 1
Order By Id
Else Expression
WITH DirectReports([QueryId],[UserName] ,[Host],[ExecStartTime],
  [Depth],[Parent_Id],[Id],[DataElement_Name] ,[DataElement_Type],
  [Clause],[func],[Join_Type] ,[Field],[Alias])
AS (SELECT [QueryId],[UserName],[Host]
,[ExecStartTime],[Depth],[Parent_Id],
      [Id],[DataElement_Name],[DataElement_Type],[Clause],[func],
      [Join_Type],[Field],[Alias]
  FROM dbo.TBL_Breaker
  WHERE [Id] in (SELECT id
          FROM dbo.TBL_Breaker
          WHERE Clause=‘select’ and DataElement_Type =‘Else
            Expression’ and QueryId = 1 and Depth = 1
          )
  and QueryId = 1 and Depth = 1
  union all
  SELECT t1.[QueryId],t1 .[UserName],t1.[Host], t1.[ExecStartTime],
      t1.[Depth] ,t1.[Parent_Id],t1.[Id],t1.[DataElement_Name],
      t1.[DataElement_Type],t1.[Clause] , t1.[func],t1.[Join_Type],
      t1.[Field],t1.[Alias]
  FROM dbo.TBL_Breaker t1
  inner join DirectReports dr
  on t1.parent_id=dr.id and t1.QueryId=dr.QueryId
  )
SELECT t1.*,t2,func as subFunc
FROM (SELECT [QueryId],[UserName],[Host]
,[ExecStartTime],[Depth],[Parent_Id]
    ,[Id],[DataElement_Name]
,[DataElement_Type],[Clause,[func],[Join_Type]
    ,[Field],[Alias]
    FROM DirectReports
    WHERE QueryId = 1 and Depth = 1
  ) t1
  inner join
  (SELECT [QueryId],[UserName],[Host]
,[ExecStartTime],[Depth],[Parent_Id]
      ,[Id],[DataElement_Name] ,[DataElement_Type] ,[Clause] ,
      [func],[Join_Type] ,[Field],[Alias]
    FROM DirectReports
  )t2
  on t1.parent_id=t2. id
WHERE t1.DataElement_Type!=‘function’ and t1.QueryId = 1and
t1.Depth = 1
union
SELECT t4.* ,t4.func as subFunc
FROM dbo.TBL_Breaker t4
WHERE Clause=‘select’ and DataElement_Type=‘Else Expression’ and
t4.QueryId = 1and t4.Depth = 1
union
SELECT t5.*,t5.func as subFunc
FROM dbo.TBL_Breaker t5
WHERE t5.id in (SELECT parent_id
          FROM dbo.TBL_Breaker
          WHERE Clause=‘select’ and DataElement_Type=‘Else
          Expression’
          )
  and t5.QueryId = 1 and t5.Depth = 1
Order By Id
```

Use of Leaf Clause characterization Rule 6 (Any filter based on one field and value, whether a mathematical or a textual expression, in a WHERE clause may be a “Value Filter” or “Member Filter”):

Some non-leaf clause components also may be characterized as described herein in the paragraph dealing with filters that should be characterized and are not leaf components, according to suitable rules such as some or all of the following 3 rules:

1. Any filter based on one field and value, whether a mathematical or a textual expression, in a WHERE clause, may be a “Value Filter” or “Member Filter”.

2. A “Weak Function Filter” in WHERE clause is characterized as follows: (a) The same table appears in the WHERE clause and in the GROUPBY clause; (b) The same field appears in the WHERE clause and in the SELECT clause of the sub-query; and (c) The Field in the SELECT clause of the sub-query does not have aggregate functions.

3. A “Strong Function Filter” in WHERE clause typically meets 5 requirements including the 3 “weak filter” requirements described herein and an additional 2 requirements, as follows:
a. The sub Query includes WHERE clause objects.
b. The SELECT clause returns one value.

The following code is an example of a method for characterizing an expression as a “Weak filter”:

```
SELECTt3.QueryId,t3.UserName,t3.Host,t3.ExecStartTime,t3.Depth,
t3.Parent_Id,t3.Id,t3.DataElement_Name,t3.DataElement_Type,
t3.Clause,t1.func,t3.func as subFunc,t3.Join_Type,t3.Field,t3.Alias
    from (select Id,func
    from [EasyOlap].[dbo].[TBL_Breaker]
    where [Clause]=‘Where’ and [DataElement_Type]=‘Function’
    and QueryId = 1 and Depth = 1
    )t1
  inner join
  ( select Parent_id
    from( SELECT Parent_id,DataElement_Type
      FROM [EasyOlap].[dbo].[TBL_Breaker]
      WHERE [Clause]=‘Where’ and QueryId = 1 and Depth = 1
        and ([DataElement_Type]=‘table’ or
        [DataElement_Type]=‘field’
        or [DataElement_Type]=‘const’ )
      group by Parent_id,DataElement_Type
      ) t4
    group by Parent_id
    having count(Parent_id)>1
  )t2
  on t1.id=t2 .Parent_id
inner join (
        SELECT *
        FROM [EasyOlap].[dbo].[TBL_Breaker]
        where QueryId = 1 and Depth = 1
      ) t3
on t1.id= t3 .Parent_id
```

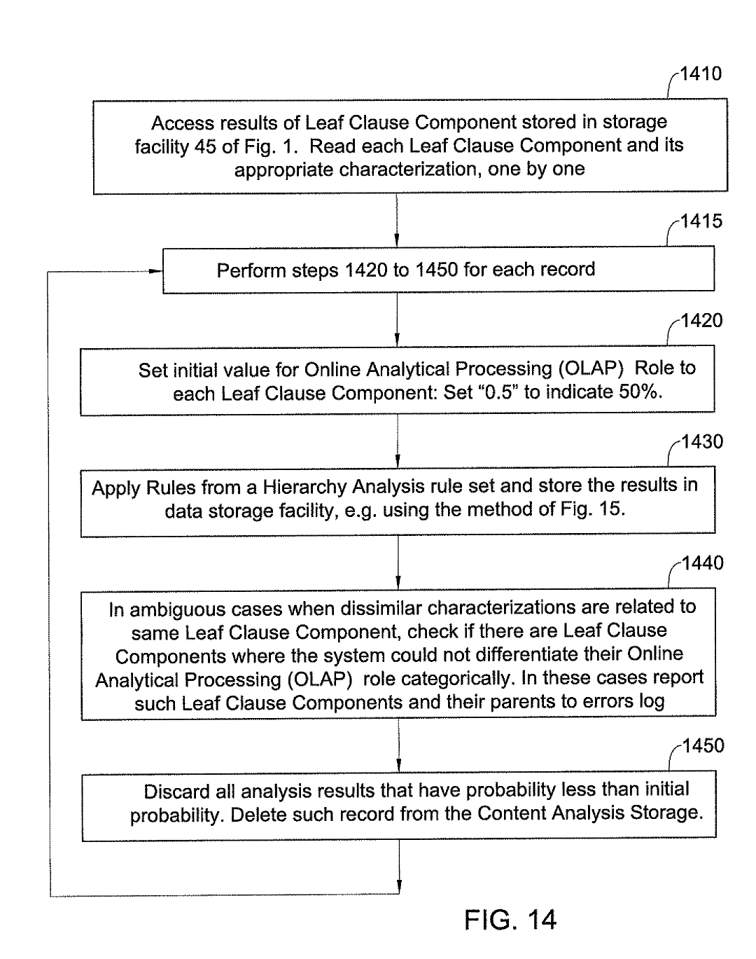

FIG. 14 is a simplified flowchart illustration of a method of operation of the Rule-Based Hierarchy Analyzer 50 of FIG. 1. The method of Fig. typically comprises some or all of the following steps, suitably ordered e.g. as shown:

In Step 1410, access results of Leaf Clause Component stored in storage facility 45 of FIG. 1. Read each Leaf Clause Component and its appropriate characterization, one by one. Perform steps 1420 to 1450 for each record.

In Step 1420, set an initial value for Online Analytical Processing (OLAP) Role to each Leaf Clause Component: Set “0.5,” to indicate 50%.

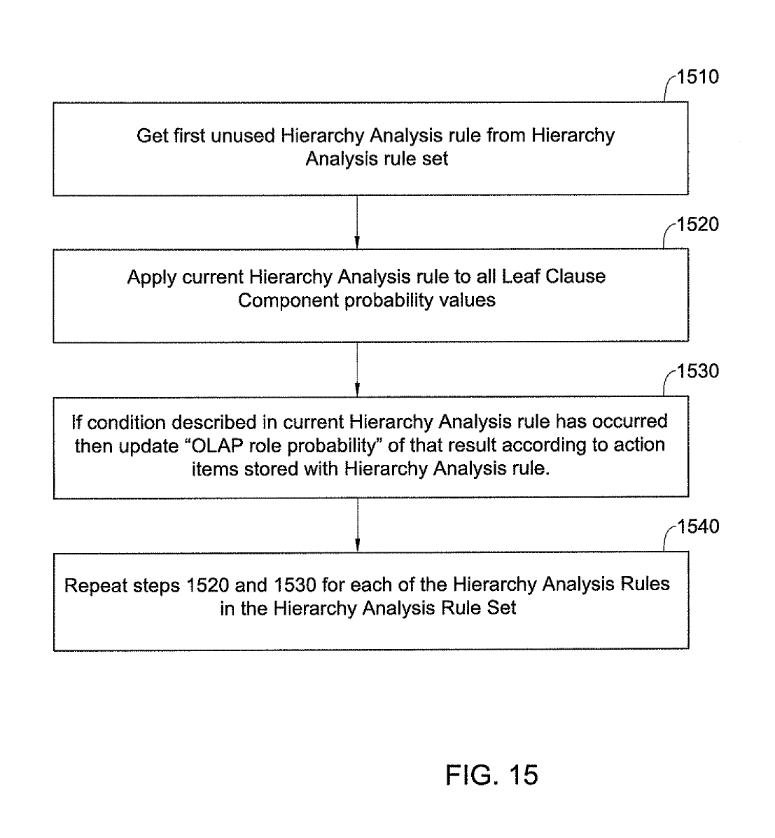

In step 1430, apply Rules from a Hierarchy Analysis rule set and store the results in data storage facility, e.g. using the method of FIG. 15.

In Step 1440, for ambiguous cases when dissimilar characterizations is related to same Leaf Clause Component, check if there are Leaf Clause Components, for which the system couldn't differentiate their Online Analytical Processing (OLAP) role categorically. In these cases report such Leaf Clause Components and their parents to errors log.

In step 1450, discard all analysis results that have probability less than initial probability. Delete such records from the Content Analysis Storage.

FIG. 15 is a simplified flowchart illustration of a method for performing the “apply Rules from a Hierarchy Analysis rule set” step of FIG. 14, the method being operative in accordance with certain embodiments of the present invention. The method of FIG. 15 typically comprises some or all of the following steps, suitably ordered e.g. as shown:

In step 1510, get a first unused Hierarchy Analysis rule from the Hierarchy Analysis rule set.

In step 1520, apply a current Hierarchy Analysis rule to all Leaf Clause Component probability values.

In step 1530, if a condition as described in a current Hierarchy Analysis rule has occurred then update “OLAP role probability” of that result according to action items stored with Hierarchy Analysis rule.

In Step 1540, repeat steps 1520 and 1530 for each of the Hierarchy Analysis Rules in the Hierarchy Analysis Rule Set.

A suitable Hierarchy Analysis rule set, including 12 rules, is now described. The rule set below is described assuming an implementation based on SQL queries, although this assumption is merely by way of example and is not intended to be limiting.

Hierarchy Analysis Rule 1:

A Field from a SELECT clause (Leaf Clause Component) that was characterized as a MEASURE increases probability of its table (table LCC) to be a FACT table by Δ and decreases the probability of its table to be a dimension table by Δ.

For example, an initial probability of 0.5 may be represented as a [WEIGHT] parameter with value 1. This value was set by initializing a second output table which receives all characterizations from an LCC clause process and adds an additional weight field whose default value is 1.

Action Item A: Increase Probability:

```
UPDATE [EasyOlap].[dbo].[TBL_ContentRules]
SET [Weight] =[Weight]+0.1 ‘our Probebility field’
WHERE [Clause]=‘From’ and [Roles]=‘Fact - measure group’
    and [DataElement_Name] in (SELECT DataElement_Name
                    FROM [EasyOlap].[dbo].[TBL_ContentRules]
                    WHERE [Clause]=‘Select’ and [func]!= ‘’
                    and QueryId = 1 and Depth = 1 )
```

Action Item B: Decrease Probability:

```
UPDATE [EasyOlap].[dbo].[TBL_ContentRules]
SET [Weight] =[Weight]−0.1
WHERE [Clause]=‘From’ and [Roles]=‘Dimension’
and [DataElement_Name] in (SELECT [DataElement_Name]
                FROM [EasyOlap].[dbo].[TBL_ContentRules]
                WHERE [Clause]=‘Select’ and [func]!= ‘’
                and QueryId = 1 and Depth = 1 )
```

Hierarchy Analysis rule 2: If there is a field in a WHERE clause that was characterized as a part of “filter” and its table was characterized as a FACT table in a FROM clause, then the probability of that filter being a “Value filter” increases by Δ and the probability of its being a “Member filter” decreases by Δ.

Action Item A: Increase Probability:

```
UPDATE [EasyOlap].[dbo].[TBL_ContentRules]
SET [Weight] =[Weight]+0.1
WHERE [Clause]=‘Where’ and [Roles]=‘Value Filter - on Measure’
    and [DataElement_Name]in (SELECT [DataElement_Name]
                  FROM [EasyOlap].[dbo].[TBL_ContentRules]
                  WHERE [Clause]=‘From’ and QueryId = 1
                  and Depth = 1 and [DataElement_Name]!=‘’
                  )
    and QueryId = 1 and Depth = 1
```

Action Item B: Decrease Probability;

```
UPDATE [EasyOlap].[dbo].[TBL_ContentRules]
SET [Weight] =[Weight]−0.1
WHERE [Clause]=‘Where’and
    [Roles]=‘Member Filter - on Dimension member’ and
    [DataElement_Name]in (SELECT DataElement_Name
                FROM [EasyOlap].[dbo].[TBL_ContentRules]
                WHERE [Clause]=‘From’ and QueryId = 1
                and Depth = 1 and[DataElement_Name] !=‘’
                )
    and QueryId = 1 and Depth = 1
```

Hierarchy Analysis rule 3: If there is a table with fields defined as dimensions by a GROUP BY clause and the same table has fields that participate in a “filter” expression in a WHERE clause, then the probability that this filter expression is to be defined as a “Member filter” increases by 1.5*Δ and the probability that it is to be defined as a “Value filter” decreases by 1.5*Δ.

Action Item A: Increase Probability:

```
UPDATE [EasyOlap].[dbo].[TBL_ContentRules]
SET [Weight] =[Weight]+0.15
WHERE [Clause]=‘Where’ and
  [Roles]=‘Member Filter - on Dimension member’ and
  [DataElement_Name] != “ and
  [DataElement_Name] in (SELECT DataElement_Name
        FROM [EasyOlap].[dbo].[TBL_ContentRules]
        WHERE [Clause]=‘Groupby’ and QueryId = 1
        and Depth = 1
        )
  and QueryId = 1 and Depth = 1
```

Action Item B: Decrease Probability:

```
UPDATE [EasyOlap].[dbo].[TBL_ContentRules]
SET [Weight] =[Weight]−0.15
WHERE [Clause]=‘Where’ and
  [Roles]=‘Value Filter - on Measure’ and
  [DataElement_Name] != “ and
  [DataElement_Name] in (SELECT [DataElement_Name]
        FROM [EasyOlap].[dbo].[TBL_ContentRules]
        WHERE [Clause]=‘Groupby’ and QueryId = 1
        and Depth = 1
        )
  and QueryId = 1 and Depth = 1
```

Hierarchy Analysis rule 4: A Table that has fields participating in a GROUP BY clause is a Dimension table, so the probability of it having a FACT table role decreases by Δ and the probability of it having a DIMENSION role increases by Δ.

Action Item A: Increase Probability:

```
UPDATE [EasyOlap].[dbo].[TBL_ContentRules]
SET [Weight] =[Weight]+0.1
WHERE [Clause]=‘From’ and [Roles]=‘Dimension’ and
  [DataElement_Name] in (SELECT DataElement_Name
        FROM [EasyOlap].[dbo].[TBL_ContentRules]
        WHERE [Clause]=‘Groupby’ and QueryId = 1
        and Depth = 1
        )
  and QueryId = 1 and Depth = 1
```

Action Item B: Decrease Probability:

```
UPDATE [EasyOlap].[dbo].[TBL_ContentRules]
SET [Weight] =[Weight]−0.1
WHERE [Clause]=‘From’ and [Roles]=‘Fact - measure group’ and
  [DataElement_Name] in (SELECT DataElement_Name
        FROM [EasyOlap].[dbo].[TBL_ContentRules]
        WHERE [Clause]=‘Groupby’ and QueryId = 1 and
        Depth = 1)
  and QueryId = 1 and Depth = 1
```

Hierarchy Analysis rule 5: Presence of a Logical operand “=” between a field name and a constant in a WHERE clause increases the probability of a “Member filter” role by 0.5Δ and decreases the probability of “Value filter” role by 0.5Δ.

Action Item A: Increase Probability:

UPDATE [EasyOlap].[dbo].[TBL_ContentRules]
SET [Weight] =[Weight]+0.05
WHERE Roles=‘Member Filter - on Dimension member’ and func =‘=’
and
QueryId = 1 and Depth = 1

Action Item B: Decrease Probability:

UPDATE [EasyOlap].[dbo].[TBL_ContentRules]
SET [Weight] =[Weight]−0.05
WHERE Roles=‘Value Filter - on Measure’ and func =‘=’ and
QueryId = 1 and Depth = 1

Hierarchy Analysis Rule 6:

Presence of logical operands “>”, “<=”, “>=” between a field name and a constant in a WHERE clause decreases the probability of a “Member filter” role by 0.5Δ and increases the probability of a “Value filter” role by 0.5Δ.

Action Item A: Increase Probability:

```
    UPDATE [EasyOlap].[dbo].[TBL_ContentRules]
    SET [Weight] =[Weight]+0.05
    FROM [EasyOlap].[dbo].[TBL_ContentRules]
    WHERE Roles=‘Value Filter - on Measure’ and func !=‘=’ and
QueryId = 1 and Depth = 1
```

Action Item B: Decrease Probability:

```
  UPDATE [EasyOlap].[dbo].[TBL_ContentRules]
  SET [Weight] =[Weight]−0.05
  FROM [EasyOlap].[dbo].[TBL_ContentRules]
  WHERE Roles=‘ Member Filter - on Dimension member’ and func !‘=’
and QueryId = 1 and Depth = 1
```

Hierarchy Analysis rule 7; Fields from an inner join that were part of a select statement have the probability of their DIMENSION role increased by Δ and the probability of their MEASURE role decreased by Δ. This rule applies also for “Inner join defined by WHERE clause”: 2 fields from different tables connected by a logical operand in a WHERE clause.

Action Item A: Increase Probability:

```
UPDATE [EasyOlap].[dbo].[TBL_ContentRules]
SET [Weight] =[Weight]+0.1
WHERE Clause=‘Select’ and Roles=‘Dimension Member property’ and
  DataElement_Name in (SELECT distinct DataElement_Name
        FROM [EasyOlap].[dbo].[TBL_ContentRules]
        WHERE [Rule]=‘inner Join - comparing Two tables
        in where clause’ and QueryId = 1 and Depth = 1
        )
  and QueryId = 1 and Depth = 1
```

Action Item B: Decrease Probability:

```
UPDATE [EasyOlap].[dbo].[TBL_ContentRules]
SET [Weight] =[Weight]−0.1
WHERE Clause=‘Select’ and Roles=‘Measure’ and
  DataElement_Name in (SELECT distinct DataElement_Name
        FROM [EasyOlap].[dbo].[TBL_ContentRules]
        WHERE [Rule]=‘inner Join - comparing Two tables
        in where clause’ and QueryId = 1 and Depth = 1
        )
  and QueryId = 1 and Depth = 1
```

Hierarchy Analysis rule 8: If CASE expression is a part of GROUP BY clause then fields that are part of “ELSE” or “THEN” parts have the probability of their Dimension role increased by Δ and the probability of their MEASURE role decreased by Δ.

Action Item A: Increase Probability:

UPDATE [EasyOlap].[dbo].[TBL_ContentRules]
SET [Weight] =[Weight]+0.1
WHERE [Rule] in (ELSE Expression - Part of Case
Expression’, ‘THEN Expression - Part of Case Expression’)
and Roles=‘Dimension Member property’ and [subFunc]=‘=’
and [Clause]=’GROUP BY’ and QueryId = 1 and Depth = 1

Action Item B: Decrease Probability:

```
UPDATE [EasyOlap].[dbo].[TBL_ContentRules]
SET [Weight] =[Weight]−0.1
WHERE [Rule] in (‘ELSE Expression - Part of Case Expression’,
‘THEN Expression - Part of Case Expression’)and
  Roles = ‘Measure’ and [subFunc]=‘=’ and [Clause]=’GROUP
    BY’ and QueryId = 1 and Depth = 1
```

Hierarchy Analysis rule 9: If in the WHEN part of a Case expression there is a field that is connected to constant by logical operand “=” then the probability of that field's DIMENSION role increases, and its MEASURE role decreases, by Δ/2.

Action Item A: Increase Probability:

```
UPDATE [EasyOlap].[dbo].[TBL_ContentRules]
SET [Weight] =[Weight]+0.05
Where [Rule]=‘When Expression - Part of Case Experssion’ and
  Roles=‘Dimension Member property’ and [subFunc]=‘=’ and
  QueryId = 1 and Depth = 1
```

Action Item B: Decrease Probability:

```
  UPDATE [EasyOlap].[dbo].[TBL_ContentRules]
  SET [Weight] =[Weight]−0.05
  Where [Rule]=‘When Expression - Part of Case Experssion’ and
Roles=‘Measure’ and [subFunc]=‘=’ and
QueryId = 1 and Depth = 1
```

Hierarchy Analysis rule 10: If there is an aggregation function applied to a whole case expression then fields in THEN and ELSE (parts of it) have the probability of their MEASURE role increased by Δ and the probability of their DIMENSION role decreased by Δ.

Action Item A: Increase Probability:

```
UPDATE [EasyOlap].[dbo].[TBL_ContentRules]
SET [Weight] =[Weight]+0.05
Where [Rule]=‘When Expression - Part of Case Experssion’ and
  Roles=‘Measure’ and ([subFunc]=‘>’ or [subFunc]=‘<’ or
  [subFunc]=‘>=’ or[subFunc]=‘<=’) and QueryId = 1 and Depth = 1
```

Action Item B: Decrease Probability:

```
UPDATE [EasyOlap].[dbo].[TBL_ContentRules]
SET [Weight] =[Weight]−0.05
WHERE [Rule]=‘When Expression - Part of Case Experssion’ and
      Roles=‘Dimension Member property’ and ([subFunc]=‘<’ or
      [subFunc]=‘>’ or [subFunc]=‘<=’ or [subFunc]=‘>=’) and
QueryId = 1 and Depth = 1
```

Hierarchy Analysis rule 1: If a string function is applied on a field then the probability of the DIMENSION role of that field increases by 0.5Δ and the probability of the MEASURE role decreases by 0.5Δ.

Then Expression

Action Item A: Increase Probability:

UPDATE [EasyOlap].[dbo].[TBL_ContentRules]
SET [Weight] =[Weight]+0.05
Where [Rule]=‘Then Expression - Part of Case Experssion’ and
Roles=‘Dimension Member property’ and [subFunc]=‘Sustr’ and
QueryId = 1 and Depth = 1

Action Item B: Decrease Probability:

UPDATE [EasyOlap].[dbo].[TBL_ContentRules]
SET [Weight] =[Weight]−0.05
WHERE [Rule]=‘Then Expression - Part of Case Expression’ and
Roles=‘Measure’ and [subFunc]=‘Sustr’ and QueryId = 1 and Depth = 1

Else Expression

Action Item A: Increase Probability:

UPDATE [EasyOlap].[dbo].[TBL_ContentRules]
SET [Weight] =[Weight]+0.05
WHERE [Rule]=‘Else Expression - Part of Case Experssion’ and
Roles=‘Dimension Member property’ and [subFunc]=‘Sustr’ and
QueryId = 1 and Depth = 1

Action item B; Decrease Probability:

UPDATE [EasyOlap].[dbo].[TBL_ContentRules]
SET [Weight] =[Weight]−0.05
Where [Rule]=‘Else Expression - Part of Case Experssion’
Roles=‘Measure’ and [subFunc]=‘Sustr’ QueryId = 1 and Depth = 1

Hierarchy Analysis Rule 12:

If a mathematical function is applied on a field then the probability of the MEASURE role of that field increases by 0.5Δ and the probability is of the DIMENSION role decreases by 0.5Δ.

### Then Expression

Action item A: Increase Probability:

```
UPDATE [EasyOlap].[dbo].[TBL_ContentRules]
SET [Weight] =[Weight]+0.05
Where [Rule]=‘Then Expression - Part of Case Experssion’ and
        Roles=‘Measure’ and [subFunc] in(‘+’ ,‘−’ ,‘*’ ,‘/’)and
        QueryId = 1 and Depth = 1
```

Action Item B: Decrease Probability:

UPDATE [EasyOlap].[dbo].[TBL_ContentRules]
SET [Weight] =[Weight]−0.05
Where [Rule]=‘Then Expression - Part of Case Experssion’ and
Roles=‘Dimension Member property’ and [subFunc] in(‘+’,‘−’,‘*’,‘/’) and
QueryId = 1 and Depth = 1

Else Expression

Action Item A: Increase Probability:

UPDATE [EasyOlap].[dbo].[TBL_ContentRules]
SET [Weight] =[Weight]+0.05
Where [Rule]=‘Else Expression - Part of Case Experssion’ and
Roles=‘Measure’ and [subFunc] in(‘+’,‘−’,‘*’,‘/’ )and = 1 and Depth = 1

Action Item B: Decrease Probability:

UPDATE [EasyOlap].[dbo].[TBL_ContentRules]
SET [Weight] =[Weight]−0.05
WHERE [Rule]=‘Else Expression - Part of Case Experssion’ and
Roles=‘Dimension Member property’ and [subFunc] in(‘+’ ,‘−’ ,‘*’ ,‘/’ )
and QueryId = 1 and Depth = 1

Typically, the hierarchy analysis rule set includes rules characterized in that:

(a) Each rule may have a Condition that can be applied to characterizations of Leaf Clause Component analysis results described above with reference to block 40 in FIG. 1 and step 410 in FIG. 4. For example, for a table (Leaf Clause Component), the condition may be Role=“Measure Group”.

(b). Each rule may have one or more action items that increase or decrease the probability of a particular Leaf Clause Component playing a particular Online Analytical Processing (OLAP) Role initially defined by the Leaf Clause Component analysis Block 40 in FIG. 1 and by step 410 in FIG. 4. In the given example (Rule 12, Action Item A), +5% is added to the Online Analytical Processing (OLAP) Role Probability, thereby increasing that probability from 50% to 55%.

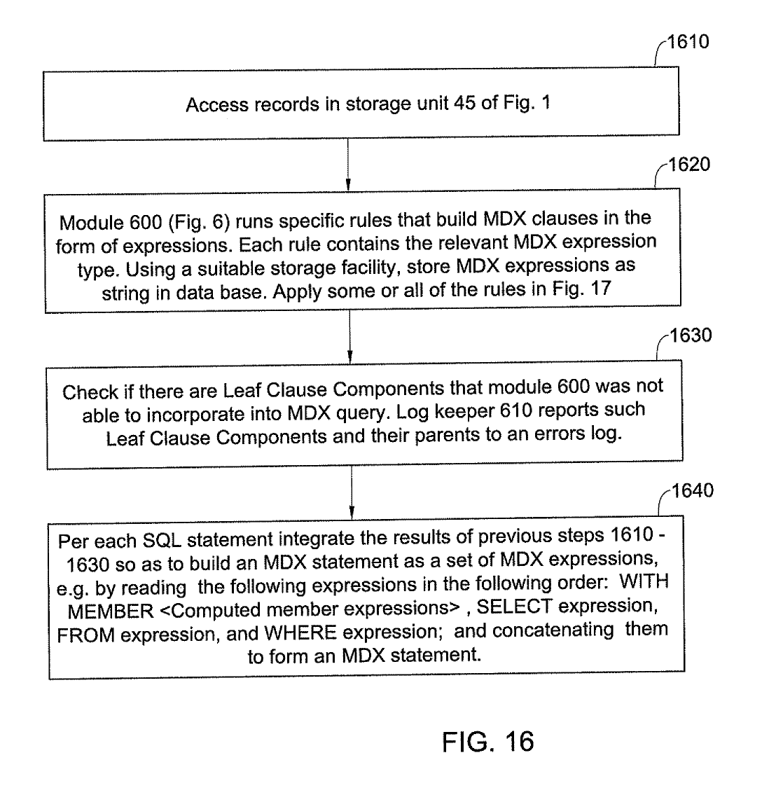

Reference is now made to FIG. 16 which is a simplified flowchart illustration of a method of operation for MDX query builder of FIG. 60. The method of FIG. 16 is operative to create a valid MDX statement and typically comprises the following two stages:

Stage I: transforming at least one, and typically all, characterized and analyzed Leaf Clause Component into parts of MDX expressions according to a predefined MDX rule set (step 1620).

Stage I: Fusing the MDX expressions generated in Stage I, into a valid MDX statement (step 1640).

The method of FIG. 16 typically comprises some or all of the following steps, suitably ordered e.g. as shown:

In Step 1610, Access records in storage unit 45 of FIG. 1.

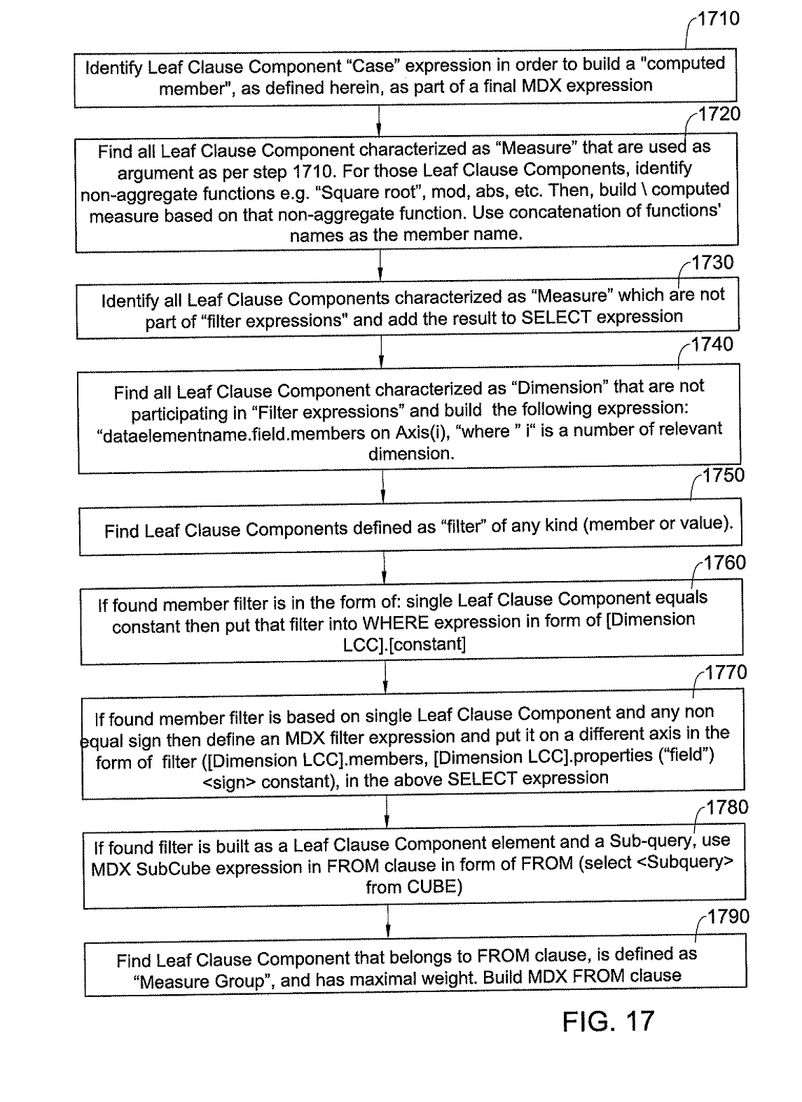

In Step 1620, module 600 (FIG. 6) runs specific rules that build MDX clauses in the form of expressions. Each rule contains the relevant MDX expression type. Using a suitable storage facility, store MDX expressions as string in data base e.g. as described in FIG. 6. Typically, apply some or all of the rules in FIG. 17 e.g. in the specified order for each SQL statement.

In Step 1630, check if there are Leaf Clause Components that module 600 wasn't able to incorporate into MDX query. Log keeper 610 reports such Leaf Clause Components and their parents to an errors log. Such an occurrence may arise in the event that step 1620 failed to recognize a specific behavior. Generally, Step 1620 applies all rules defined, the rules having been defined based on prior knowledge of MDX syntax. However, some SQL expressions are best translated into MDX syntax forms not covered in the predefined rules. In this case, the relevant LCC and its possible OLAP role are reported to be untranslatable.

In Step 1640, per each SQL statement integrate the results of previous steps 1610-1630 so as to build an MDX statement as a set of MDX expressions, e.g. by reading the following expressions in the following order: WITH MEMBER <Computed member expressions>, SELECT expression, FROM expression, and WHERE expression; and concatenating them to form an MDX statement. For example, a typical MDX statement comprising all 4 types of expressions is the following:

```
WITH MEMBER [Date].[Calendar].[First8Months2003] AS
  Aggregate(
    PeriodsToDate(
      [Date].[Calendar].[Calendar Year],
      [Date].[Calendar].[Month].[August 2003]
    )
  )
SELECT
  [Date].[Calendar].[First8Months2003] ON axis(0),
  [Product].[Category].Children ON axis(1)
FROM
  [Adventure Works]
WHERE [Measures].[Order Quantity]
```

```
Step 1640 integrates all the MDX expressions from types of WITH
MEMBER, SELECT, FROM, WHERE in that order. In the example,
this expression:
“[Date].[Calendar].[First8Months2003] AS
  Aggregate(
    PeriodsToDate(
      [Date].[Calendar].[Calendar Year],
      [Date].[Calendar].[Month].[August 2003]
    )
  )
” is a WITH MEMBER expression, based on a rule described in step
1720.
```

The following:

[Date].[Calendar].[First8 Months2003] ON axis(0),

[Product].[Category] Children ON axis(1) are two result expressions from step 1740 applied sequentially.

“[Adventure Works]” is a FROM expression from rule in step 1790.

“[Measures].[Order Quantity] ” is a WHERE MDX expression received as a result set from applying a rule in case (i) of step 1730 in FIG. 17.

FIG. 17 is a simplified flowchart illustration of a method for performing the MDX clause building Step of FIG. 16, the method being operative in accordance with certain embodiments of the present invention. The method of FIG. 17 typically comprises some or all of the following steps, suitably ordered e.g. as shown:

In Step 1710, identify Leaf Clause Component “Case” expression in order to build a “computed member”, as defined herein, as part of a final MDX expression.

To do so, the following steps may be performed:

(a) Transform those Leaf Clause Components to IIF format, using the standard IIF expression format of MDX, and

(b) name the member, using the Leaf Clause Component “alias” field as the name for that member.

In Step 1720, find all Leaf Clause Component characterized as “Measure” that are used as argument as per step 1710. For those Leaf Clause Components, identify non-aggregate functions e.g. “Square root”, mod, abs, etc. Then, build a computed measure based on that non-aggregate function. Use concatenation of functions' names as the member name.

In step 1730, identify all Leaf Clause Components characterized as “Measure” which are not part of “filter expressions” e.g. by acting as described for each of the following cases (i)-(iv), and add the result to SELECT expression:

```
i. If there is only one Measure Leaf Clause Component then build
a WHERE expression as follows:
WHERE Measures. <Measure name>, where measure name is a
field name of Leaf Clause Component. For the measure use the
following:
SELECT Field
FROM [EasyOlap].[dbo].[TBL_ContentRules]
WHERE [Clause]=‘Select’ and
  [Roles]= ‘Measure’ and
    [Rule]=‘Aggregate function in Select statement’ and
  [Weight]>=1 and QueryId=1 and Depth=1
HAVING count(*)=1
ii. If there is more than one measure, then build measures
axis in following way:
SELECT {Measures.Measure1, Measures.Measure2,
Measures.Measure3} on columns. To get list of measures use
following:
SELECT Field
FROM [EasyOlap].[dbo].[TBL_ContentRules]
WHERE [Clause]=‘Select’ and
  [Roles]= ‘Measure’ and
    [Rule]=‘Aggregate function in Select statement’ and
  [Weight]>=1 and QueryId=1 and Depth=1
iii. If Case expression defined previously, in step 1710, is defined
as “Measure” then add the following expression:
Measures.Alias inside { }. To get list of measure aliases use
following:
SELECT Alias
FROM [EasyOlap].[dbo].[TBL_ContentRules]
WHERE [Clause]=‘Select’ and
  [Roles]= ‘Measure’ and
  [DataElement_Type]=’Case Expression’
  [Weight]>=1 and QueryId=1 and Depth=1
iv. If there are any computed measures (i.e. if the output of step
1720 was not an empty step), add them to previous item result in
same way as CASE was added (as done re step 1710).
```

In Step 1740, find all Leaf Clause Component characterized as “Dimension” that are not participating in “Filter expressions” and build the following expression: “dataelementname.field.members on Axis(i), “where “i” is a number of relevant dimension. To get a list of relevant dimensions in pairs of “dataelementname, field” use the following and add the result to a SELECT expression, e.g.:

```
    SELECT DataElement_Name,Field
    FROM [EasyOlap].[dbo].[TBL_ContentRules]
    WHERE [Clause]=‘Select’ and [Roles]= ‘Dimension Member
    property’ and [Weight]>=1 and QueryId = 1
    and Field not in(SELECT distinct Field
            FROM [EasyOlap].[dbo].[TBL_ContentRules]
            WHERE [Clause]=‘Groupby’ and [Roles]=‘Dimension
            Level’
    and
                  [Weight]>=1 and QueryId = 1
            )
    and Field not in(SELECT Field
FROM TBL_ContentRules
WHERE QueryId = 1 and Roles=‘Function Filter’ and
id = (Select min(id)
    FROM TBL_ContentRules
    WHERE QueryId = 1 and Roles=‘Function Filter’
    )
union
SELECT max(Field)as Field
        FROM [EasyOlap].[dbo].[TBL_ContentRules]
where (Roles =‘Value Filter - on Measure’ or
    Roles=‘Member Filter - on Dimension member’)
and QueryId = 1 and Clause=‘where’ and
Depth in (SELECT distinct Depth
      FROM [EasyOlap].[dbo].[TBL_ContentRules]
      WHERE QueryId = 1 and Roles= ‘Function Filter’
      and Parent_Id =
      (SELECT id
        FROM EasyOlap].[dbo].[TBL_ContentRules]
        WHERE QueryId = 1 and Roles= ‘Function Filter’
        and func != “
      )
      )
    Group By id
```

In Step 1750, Find Leaf Clause Components defined as “filter” of any kind (member or value).

In Step 1760, if found member filter is in the form of: single Leaf Clause Component equals constant then put that filter into WHERE expression in form of [Dimension LCC].[constant].

In Step 1770, if found member filter is based on single Leaf Clause Component and any non equal sign then define an MDX filter expression and put it on a different axis in the form of filter ([Dimension LCC].members, [Dimension LCC].properties (“field”) <sign> constant), in the above SELECT expression.

In Step 1780, if a found filter is built as a Leaf Clause Component element and a Sub-query, use MDX SubCube expression in FROM clause in form of FROM (select <Subquery> from CUBE)

In Step 1790, find a Leaf Clause Component that belongs to FROM clause, is defined as “Measure Group”, and has maximal weight. Build MDX FROM clause as “FROM <Measure_Group_Name>”

SELECT a.DataElement_Name FROM
[EasyOlap].[dbo].[TBL_ContentRules] a WHERE a.Roles=‘Fact -
measure group’ and QueryId=1 and Depth=1 and Id=(SELECT min(b.id)
FROM [EasyOlap].[dbo].[TBL_ContentRules] WHERE
b.[Clause]=‘From’ and b.Roles=‘Fact - measure group’ and b.QueryId=1
and b.Depth=1 and b.weight =(SELECT max(c.weight)FROM
[EasyOlap].[dbo].[TBL_ContentRules] c WHERE c.[Clause]=‘From’ and
c.Roles=‘Fact - measure group’ and c.[Weight]>1 and c.QueryId=1 and
c.Depth=1 ))

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software.

Features of the present invention which are described in the context of separate embodiments may also be provided in combination in a single embodiment. Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting.

1. A data system operative in conjunction with a data storage unit operative to store data and a query processor operative to accept queries with respect to the data in the data storage unit and to formulate responses to the queries by accessing the data storage unit, the data system comprising:
a query analyzer operative to perform breakdown analysis of queries thereby to generate a hierarchical representation of each of at least some queries received by the query processor; and
a hierarchical query storage unit operative to store said hierarchical representations.

2. A system according to claim 1 wherein said query analyzer comprises:
apparatus for breaking down an input query on the data storage unit into a set of at least one clauses; and
apparatus for recursively breaking down at least one of said plurality of clauses into a set of at least one clause components,
thereby to define a hierarchical representation of said input query.

3. A system for performing breakdown analysis of queries on at least one relational data storage unit, the system comprising:
apparatus for breaking down an input query on a data storage unit into a set of at least one clauses; and
apparatus for recursively breaking down at least one of said plurality of clauses into a set of at least one clause components,
thereby to define a hierarchy representing said input query and comprising clauses below the input query and clause components below the clauses, wherein some of said clause components are leaves which are not parents of any other clause component.

4. A system according to claim 1 and also comprising a hierarchy analyzer operative to analyze at least one leaf clause component of an individual hierarchy and comprising:
a leaf clause component characterization unit operative to generate an initial characterization of at least one leaf clause component as at least one of a dimension, a measure within a multi-dimensional query definition language; and
a cross-analyzer operative to generate an advanced characterization of at least one leaf clause component as exactly one of a dimension and a measure within a multi-dimensional query definition language.

5. A system according to claim 4 and also comprising a meta-data analyzer having access rights to said data storage unit and operative to narrow the initial characterization of at least one leaf clause component which is a field in said data storage unit.

6. A system according to claim 1 wherein said hierarchical query storage unit comprises a parent-child structure.

7. A system according to claim 3 wherein said input query comprises an SQL statement.

8. A system according to claim 3 wherein said input query comprises an XML statement.

9. A system according to claim 3 wherein said input query is represented as a string of characters.

10. A system according to claim 1 wherein said data storage unit comprises at least one table.

11. A system according to claim 2 and also comprising apparatus for generating an MDX query from said clause components.

12. A system according to claim 1 wherein data stored in said data storage unit is stored in a relational format and wherein said query processor comprises an SQL processor.

13. A system according to claim 4 and also comprising apparatus for generating an MDX query from said clause components by selecting at least one leaf clause component whose advanced characterization is “dimension” to define at least one dimension axis of the MDX query.

14. A system according to claim 5 and also comprising apparatus for generating an MDX query from said clause components by partitioning a set of leaf clause components whose advanced characterization is “measure” into a first “measure” subset and a second “filter” subset, defining a measure axis for the MDX query based on the leaf clause components in the first “measure” subset and defining the leaf clause components in the second “filter” subsets as filters on said at least one dimension axis.

15. A system according to claim 2 and also comprising a hierarchy analyzer operative to analyze at least one leaf clause component of an individual hierarchy and comprising:
a leaf clause component characterization unit operative to generate an initial characterization of at least one leaf clause component as at least one of a dimension and a measure within a multi-dimensional query definition language; and
a cross-analyzer operative to generate an advanced characterization of at least one leaf clause component as exactly one of a dimension and a measure within a multi-dimensional query definition language.

16. A system according to claim 15 wherein said apparatus for recursively breaking down is operative to break down each “from” clause into a set of at least one clause components including at least one leaf clause component each defining a table within said data storage unit which is associated with the “from” clause,
and wherein said cross-analyzer is also operative to characterize each leaf clause component defining a table as either a dimension table or a fact table.

17. A system according to claim 3, wherein said input query is represented as an XML expression.

18. A system according to claim 3, wherein said input query is represented as an XMLA expression.

19. A system according to claim 9 wherein said string of characters comprises an MDX string.

20. A system according to claim 1 and also comprising a data storage unit operative to store data.

21. A query processing method operative in conjunction with a data storage unit operative to store data and a query processor operative to accept queries with respect to the data in the data storage unit and to formulate responses to the queries by accessing the data storage unit, the method comprising:
performing a breakdown analysis of queries thereby to generate a hierarchical representation of each of at least some queries received by the query processor.

22. A method for performing breakdown analysis of queries on at least one relational data storage unit, the method comprising:
breaking down an input query on a data storage unit into a set of at least one clauses; and
recursively breaking down at least one of said plurality of clauses into a set of at least one clause components including defining a hierarchy representing said input query and comprising clauses below the input query and clause components below the clauses, wherein some of said clause components are leaves which are not parents of any other clause component.

23. A system according to claim 1 and also comprising a query processor operative to accept queries with respect to the data in the data storage unit and to formulate responses to the queries by accessing the data storage unit.

24. A system according to claim 1 and also comprising a relational database management system including:
a data storage unit operative to store data; and
a query processor operative to accept queries with respect to the data in the data storage unit and to formulate responses to the queries by accessing the data storage unit.
